(19) United States
(12) Patent Application Publication
(10) Pub. No.: US 2022/0274410 A1
(43) Pub. Date: Sep. 1, 2022

(54) INK INJECTION CYLINDER, INK TANK, AND INKJET PRINTER EQUIPPED WITH THE SAME

(71) Applicant: BROTHER KOGYO KABUSHIKI KAISHA, Nagoya (JP)

(72) Inventors: Yoshinori OSAKABE, Seto (JP); Naoya OKAZAKI, Hashima (JP); Satoshi MIYASE, Nagoya (JP); Hikaru TAMURA, Okazaki (JP); Akinari ISHIBE, Okazaki (JP); Fumio NAKAZAWA, Okazaki (JP); Taichi SHIRONO, Nagoya (JP); Tsuyoshi KUWAYAMA, Kasugai (JP); Masahiro HAYASHI, Nishio (JP)

(73) Assignee: BROTHER KOGYO KABUSHIKI KAISHA, Nagoya (JP)

(21) Appl. No.: 17/733,184

(22) Filed: Apr. 29, 2022

Related U.S. Application Data
(63) Continuation-in-part of application No. PCT/JP2020/040206, filed on Oct. 27, 2020.

(30) Foreign Application Priority Data
Oct. 31, 2019 (CN) 201921862095.2
Oct. 31, 2019 (CN) 201921862172.4
Oct. 31, 2019 (CN) 201921862218.2
Oct. 31, 2019 (CN) 201921862220.X
Oct. 31, 2019 (CN) 201921862296.2
Oct. 31, 2019 (CN) 201921862299.6
Oct. 31, 2019 (CN) 201921864414.3
Oct. 31, 2019 (CN) 201921864431.7
Oct. 31, 2019 (CN) 201921864576.7

(51) Int. Cl. B41J 2/175

(52) U.S. Cl. CPC B41J 2/17506; B41J 2/17513; B41J 2/17553; B41J 2/17523

(57) ABSTRACT

An ink injection cylinder includes a first flow path tube and a second flow path tube extending in a longitudinal direction. The first flow path tube has a first opening on one side in the longitudinal direction, a second opening on another side in the longitudinal direction, and a first flow path formed between the first and second openings. The second flow path tube has a third opening on the one side in the longitudinal direction, a fourth opening on the other side in the longitudinal direction, and a second flow path formed between the third and fourth openings. At least one of a first virtual plane including at least a portion of an end surface of the second opening and a second virtual plane including at least a portion of an end surface of the fourth opening intersects with a plane orthogonal to the longitudinal direction.

### CROSS REFERENCE TO RELATED APPLICATIONS

This is a Continuation-in-Part of International Application No. PCT/JP2020/040206 filed on Oct. 27, 2020, which claims priority from Chinese Patent Application No. 201921864431.7 filed on Oct. 31, 2019, Chinese Patent Application No. 201921864414.3 filed on Oct. 31, 2019, Chinese Patent Application No. 201921862299.6 filed on Oct. 31, 2019, Chinese Patent Application No. 201921862218.2 filed on Oct. 31, 2019, Chinese Patent Application No. 201921862220.X filed on Oct. 31, 2019, Chinese Patent Application No. 201921862095.2 filed on Oct. 31, 2019, Chinese Patent Application No. 201921862172.4 filed on Oct. 31, 2019, Chinese Patent Application No. 201921864576.7 filed on Oct. 31, 2019, and Chinese Patent Application No. 201921862296.2 filed on Oct. 31, 2019. The entire disclosures of the prior applications are incorporated herein by reference.

### BACKGROUND

Aspects of the present disclosure relate to a technical field of printers, and more specifically to ink injection cylinders, ink tanks, and inkjet printers equipped with the ink injection cylinders and the ink tanks.

An inkjet printer generally performs recording by ejecting ink from a recording engine toward a recording medium (e.g., a recording sheet). FIG. 1 a diagram showing a conventional inkjet printer 1. For ease of understanding of the following description, a direction in which the inkjet printer 1 faces the user is defined as “front,” the opposite direction is defined as “rear,” the left hand side of the user is defined as “left,” and the right hand side of the user is defined as “right” with respect to a position at which the user uses the inkjet printer 1.

As illustrated in FIG. 1, the inkjet printer 1 includes a printer main body 2, and four ink tanks 10 are disposed on one end side (e.g., the front side) of the printer main body 2. The printer main body 2 includes a housing 3, and the four ink tanks 10 are disposed within the housing 3. One of the ink tanks 10 is disposed at the left front portion of the housing 3, and the other three ink tanks 10 are disposed at the right front portion of the housing 3. The ink tanks 10 are used to store ink and supply ink to a recording engine 9. The ink tank 10 at the left front portion stores black ink, and the three ink tanks 10 at the right front portion store cyan, magenta and yellow ink, respectively. Thus, the inkjet printer 1 can record a color image having a rich color. Generally, ink is injected into these ink tanks 10 from not-shown ink bottles storing ink.

As shown in FIGS. 2 and 3, the ink tank 10 mainly includes an ink tank main body 30 and an ink injection cylinder 20. The ink injection cylinder 20 is detachably attached to the ink tank main body 30. The ink tank main body 30 includes a resin member and a film 39.

The ink tank main body 30 mainly includes an ink storage chamber 31, an ink injecting part 33, buffer chambers 34, an ink supplying part 35, an air communicating part 36, and a viewing surface 37 through which a user can see an ink liquid surface inside the ink storage chamber 31. The ink storage chamber 31 stores ink to be supplied to the recording engine 9. The ink injecting part 33 is provided at an upper portion of the ink storage chamber 31 and includes an ink injection port 32. Ink passing through the ink injection port 32 is injected into the ink tank main body 30, and is stored in the ink storage chamber 31. The ink supplying part 35 is provided at an upper portion the ink storage chamber 31, and supplies ink stored in the ink storage chamber 31 to the recording engine 9. The air communicating part 36 is provided at a lower portion the ink tank main body 30 and includes an air communication port 38. The air communication port 38 is in air communication with the ink storage chamber 31 via the buffer chambers 34.

The ink injection cylinder 20 includes a main body 21 extending along a longitudinal direction L. The main body 21 includes a first end 23 and a second end 24 opposed to the first end 23 along the longitudinal direction L. The main body 21 includes a first flow path tube 40 and a second flow path tube 50 extending along the longitudinal direction L. The first flow path tube 40 includes a first opening 41, a second opening 42, and a first flow path 43 formed between the first opening 41 and the second opening 42. The second flow path tube 50 includes a third opening 51, a fourth opening 52, and a second flow path 53 formed between the third opening 51 and the fourth opening 52.

The ink injection cylinder 20 further includes mounts 22 provided outside the main body 21. The mounts 22 are formed integrally with the main body 21. Each mount 22 includes a hook projecting outward. The ink tank main body 30 includes, inside the ink storage chamber 31, a not-shown rib projecting toward the bottom of the ink storage chamber 31. When mounting the ink injection cylinder 20 to the ink tank main body 30, the ink injection cylinder 20 is inserted into the ink storage chamber 31 through the ink injection port 32 of the ink tank main body 30. When the mounts 22 move to a position of the rib along with the movement of the ink injection cylinder 20, the mounts 22 engage with the rib with the hooks. In this manner, the ink injection cylinder 20 is fixed to the ink tank main body 30.

In a state where the ink injection cylinder 20 is mounted to the ink tank main body 30, the first opening 41 and the third opening 51 are located above the top of the ink injection port 32, in other words, the first opening 41 and the third opening 51 are disposed outside the ink storage chamber 31, and the first opening 41 and the third opening 51 are used to inject ink from the ink bottle into the ink tank. The second opening 42 and the fourth opening 52 are disposed within the ink storage chamber 31 and away from a bottom wall of the ink storage chamber 31.

After the ink injection cylinder 20 is mounted to the ink tank main body 30, a bottle mouth of the ink bottle can be inserted into the ink injecting part 33 of the ink tank main body 30, thereby covering the top end of the ink injection cylinder 20. In this manner, the ink in the ink bottle enters the first flow path 43 or the second flow path 53 through the first opening 41 or the third opening 51, and then enters the ink storage chamber 31 through the second opening 42 or the fourth opening 52. At the same time, air inside the ink storage chamber 31 also enters the ink bottle through the other of the first flow path 43 and the second flow path 53. In this state, since the flow of ink and the flow of air proceed simultaneously in respective flow paths, “gas-liquid replacement” occurs.

### SUMMARY

When either the flow of ink or the flow of air stops in the first flow path 43 and the second flow path 53, the “gas-liquid replacement” also stops. In an ideal situation, when the ink storage chamber 31 is filled with ink (the ink liquid surface reaches the two openings of the ink injection cylinder 20 (the second opening 42 and the fourth opening 52) located in the ink storage chamber 31) or when all of the ink in the ink bottle is injected into the ink storage chamber 31, the ink injection process stops.

However, the applicant has found that, during the actual ink injection to the ink tank 10 shown in FIGS. 2 and 3, the ink injection temporarily stops. That is, only a small amount of ink is injected from the ink bottle into the ink tank main body 30 and, although there is still ink remaining in the ink bottle, the ink injection temporarily stops while there still remains a large space in the ink storage chamber 31 which is not filled with ink. The applicant came to the idea that, in the ink injection process, meniscus may be formed at the second opening 42 and/or the fourth opening 52 of the ink injection cylinder 20 in the ink storage chamber 31, thereby inhibiting further flow of ink or air.

At least one aspect of the present disclosure is advantageous to provide an ink injection cylinder, an ink tank and an inkjet printer that can prevent occurrence of the problem that may occur in conventional ink injection cylinders, ink tanks and inkjet printers, that is, the temporally stop of ink injection during the ink injection process.

According to aspects of the present disclosure, there is provided an ink injection cylinder used for injecting ink into an ink tank having an ink injection port. The ink injection cylinder includes a first flow path tube and a second flow path tube. The first flow path tube extends in a longitudinal direction and has a first opening on one side in the longitudinal direction, a second opening on another side in the longitudinal direction, and a first flow path formed between the first opening and the second opening. The second flow path tube extends in the longitudinal direction and has a third opening on the one side in the longitudinal direction, a fourth opening on the other side in the longitudinal direction, and a second flow path formed between the third opening and the fourth opening. At least one of a first virtual plane including at least a portion of an end surface of the second opening of the first flow path tube and a second virtual plane including at least a portion of an end surface of the fourth opening of the second flow path tube intersects with a plane orthogonal to the longitudinal direction.

According to aspects of the present disclosure, there is further provided an ink tank for use in an inkjet printer having a recording engine. The ink tank includes an ink tank main body and a film adhered thereto. The ink tank main body includes an ink storage chamber configured to store ink to be supplied to the recording engine, an ink injection port in communication with the ink storage chamber, and the ink injection cylinder described above. The ink injection cylinder extends through the ink injection port to the ink storage chamber, and the first opening and the third opening are disposed outside the ink tank main body. The first flow path communicates with the ink storage chamber through the second opening, and the second flow path communicates with the ink storage chamber through the fourth opening.

According to aspects of the present disclosure, there is further provided an inkjet printer including a recording engine and the ink tank described above.

Due to at least one of the first virtual plane including at least a portion of the end surface of the second opening and the second virtual plane including at least a portion of the end surface of the fourth opening intersecting with the plane orthogonal to the longitudinal direction, the formation of meniscus at at least one of the second opening of the first flow path tube and the fourth opening of the second flow path tube can be suppressed and thus the temporary stop of ink injection during the injection process can be prevented.

### BRIEF DESCRIPTION OF THE DRAWINGS

FIG. 1 is a perspective view of a conventional inkjet printer, and further shows an appearance of the inkjet printer of the present disclosure.

FIG. 2 is a perspective view of an ink tank main body mounted on the conventional inkjet printer and an ink injection cylinder not mounted on the ink tank main body.

FIG. 3 is a perspective view of the conventional ink tank after the ink injection cylinder shown in FIG. 2 is mounted to the ink tank main body.

FIG. 4 shows an ink tank according to the first embodiment of the present disclosure.

FIG. 5 shows an ink tank according to Modification 1 of the first embodiment of the present disclosure.

FIG. 6 shows an ink tank according to Modification 2 of the first embodiment of the present disclosure.

FIG. 7 shows an ink tank according to a Modification 3 of the first embodiment of the present disclosure.

FIG. 8 shows an ink tank according to Modification 4 of the first embodiment of the present disclosure.

FIG. 9 is a perspective view of an ink tank after an ink injection cylinder according to the second embodiment of the present disclosure is mounted to the ink tank main body.

FIG. 10 is a partial cross-sectional view of the ink injection cylinder of FIG. 9 cut along line A-A.

FIG. 11 is a partial cross-sectional view of an ink injection cylinder according to Modification 1 of the second embodiment of the present disclosure cut along line A-A.

FIG. 12 is a partial cross-sectional view of an ink injection cylinder according to Modification 2 of the second embodiment of the present disclosure cut along line A-A.

FIG. 13 is a partial cross-sectional view of an ink injection cylinder according to Modification 3 of the second embodiment of the present disclosure cut along line A-A.

FIG. 14 is a partial cross-sectional view of an ink injection cylinder according to Modification 4 of the second embodiment of the present disclosure cut along line A-A.

FIG. 15 shows a state where an ink injection cylinder according to the third embodiment of the present disclosure is not mounted to the ink tank main body.

FIG. 16 shows an ink injection cylinder according to Modification 1 of the third embodiment of the present disclosure.

FIG. 17 is a perspective view of an ink injection cylinder according to Modification 2 of the third embodiment of the present disclosure as viewed from diagonally above.

FIG. 18 is a perspective view of an ink injection cylinder according to Modification 3 of the third embodiment of the present disclosure as viewed from diagonally below.

FIG. 19 shows an ink injection cylinder according to Modification 4 of the third embodiment of the present disclosure.

FIG. 20 shows an ink injection cylinder according to Modification 5 of the third embodiment of the present disclosure.

FIG. 21 is a partial cross-sectional view of an ink injection cylinder according to the fourth embodiment of the present disclosure cut along line A-A.

FIG. 22 is a plan view of the ink injection cylinder according to the fourth embodiment of the present disclosure as viewed from below in the vertical direction.

FIG. 23 is a cross-sectional view of an ink injection cylinder according to Modification 1 of the fourth embodiment of the present disclosure cut along line A-A.

FIG. 24 is a plan view of the ink injection cylinder according to Modification 1 of the fourth embodiment of the present disclosure as viewed from below in the vertical direction.

FIG. 25 is a cross-sectional view of an ink injection cylinder according to Modification 2 of the fourth embodiment of the present disclosure cut along line A-A.

FIG. 26 is a plan view of an ink injection cylinder according to the fifth embodiment of the present disclosure as viewed from below in the vertical direction.

FIG. 27 is a cross-sectional view of a first flow path tube of the ink injection cylinder according to the fifth embodiment of the present disclosure cut along line A-A in FIG. 26.

FIG. 28 is a perspective view of an ink tank after an ink injection cylinder according to the sixth embodiment of the present disclosure is mounted to the ink tank main body.

FIG. 29 is a cross-sectional view of the ink injection cylinder according to the sixth embodiment of the present disclosure cut along line B-B in FIG. 28.

FIG. 30 is a cross-sectional view of the ink injection cylinder according to the sixth embodiment of the present disclosure cut along line C-C in FIG. 29.

FIG. 31 is a cross-sectional view of an ink injection cylinder according to Modification 1 of the sixth embodiment of the present disclosure cut at the same position as the line C-C in FIG. 29.

FIG. 32 is a cross-sectional view of an ink injection cylinder according to Modification 2 of the sixth embodiment of the present disclosure cut at the same position as the line C-C in FIG. 29.

FIG. 33 is a side view showing an ink tank according to the seventh embodiment of the present disclosure.

FIG. 34 is a perspective view of an ink injection cylinder according to the seventh embodiment of the present disclosure.

FIG. 35 is a cross-sectional view of an ink injection cylinder according to the seventh embodiment of the present disclosure cut along line B-B in FIG. 34.

FIG. 36 is a side view showing an ink tank according to Modification 1 of the seventh embodiment of the present disclosure.

FIG. 37 is a side view showing an ink tank according to Modification 2 of the seventh embodiment of the present disclosure.

FIG. 38 is a perspective view of an ink tank according to the eighth embodiment of the present disclosure.

FIG. 39 is a plan view of the ink tank according to the eighth embodiment of the present disclosure cut along line B-B in FIG. 38.

FIG. 40 is a perspective view of an ink tank according to Modification 1 of the eighth embodiment of the present disclosure.

FIG. 41 is a plan view of the ink tank of Modification 1 in the eighth embodiment of the present disclosure cut along line C-C in FIG. 40.

FIG. 42 is a side view showing an ink tank according to Modification 2 of the eighth embodiment of the present disclosure.

FIG. 43 is a side view of an ink tank according to the ninth embodiment of the present disclosure.

FIG. 44 is a plan view of the ink tank according to the ninth embodiment of the present disclosure cut along line B-B of FIG. 43.

FIG. 45 is a perspective view of an ink tank according to Modification 1 of the ninth embodiment of the present disclosure.

FIG. 46 is a perspective view of an ink tank according to a Modification 2 of the ninth embodiment of the present disclosure.

FIG. 47 is a side view showing an ink tank according to Modification 3 of the ninth embodiment of the present disclosure.

### DETAILED DESCRIPTION

Various embodiments of the present disclosure will be described in detail below with reference to the drawings. Those skilled in the art of this field will recognize that not only one embodiment but multiple embodiments can be implemented in combination.

The present embodiment will be described below with reference to the drawings. In the following description, the terms “top,” “bottom” and the like are used for ease of explanation, but the contents of the disclosure are not limited by the terms.

In the text of the description in the present application, the ordinals such as “first” and “second” are merely identifiers, and thus do not imply that there is no other structure and do not represent, for example, a specific order. Moreover, for example, the expression “first member” does not imply the presence of “second member,” and the expression “second member” does not imply the presence of the “first member.”

An inkjet printer 100 of the present disclosure has substantially the same structure as the inkjet printer 1 of the background art. The inkjet printer 100 of the present disclosure may have various functions such as a function of scanning an image, a facsimile function and a copy function, in addition to a printing function. The printing function may include a double-sided image recording function for recording images on both sides of a recording sheet. Functions other than the printing function may be optional.

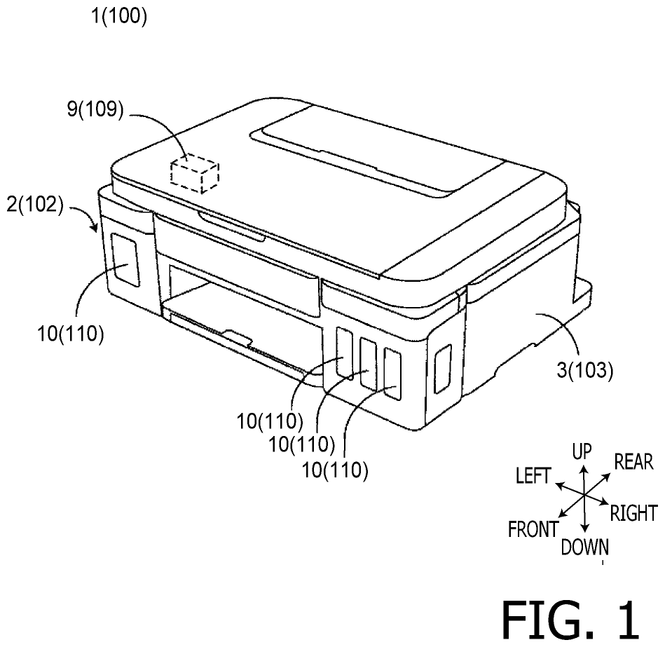

As shown in FIG. 1, the inkjet printer 100 includes a printer main body 102 and ink tanks 110.

The printer main body 102 has a substantially rectangular parallelepiped shape. The printer main body 102 is provided with a feed tray for feeding recording sheets and a discharge tray for discharging the recording sheets. A recording engine 109 having, for example, a plurality of nozzles is provided inside the printer main body 102, and the recording engine 109 ejects ink toward a recording sheet. An operation panel may be provided on the upper surface of the printer main body 102, and the operation panel may be provided with a display for displaying various pieces of information and contents of settings, and operation keys for performing various operations and inputting the contents of settings. In some embodiments, the display may not be provided and only the operation keys may be provided. The operation keys may also be provided at appropriate positions of the printer main body 102 such as, for example, on the front surface.

The inkjet printer 100 includes four ink tanks 110, and one of the ink tanks 110 is disposed at the left front portion of the printer main body 102 and stores black ink. The other three ink tanks 110 are disposed at the right front portion of the printer main body 102, and the three ink tanks 110 store cyan, magenta, and yellow inks in this order from left to right, respectively. Thus, the inkjet printer 100 can record a color image using four inks of black, cyan, magenta, and yellow colors.

The printer main body 102 includes a housing 103, and the four ink tanks 110 are provided inside the housing 103. The number of ink tanks 110 may not be four, and the ink tanks 110 may be provided at other positions of the housing 103. In addition, the ink tanks 110 may be fixed to the printer main body 102 or may be detachably mounted to the printer main body 102.

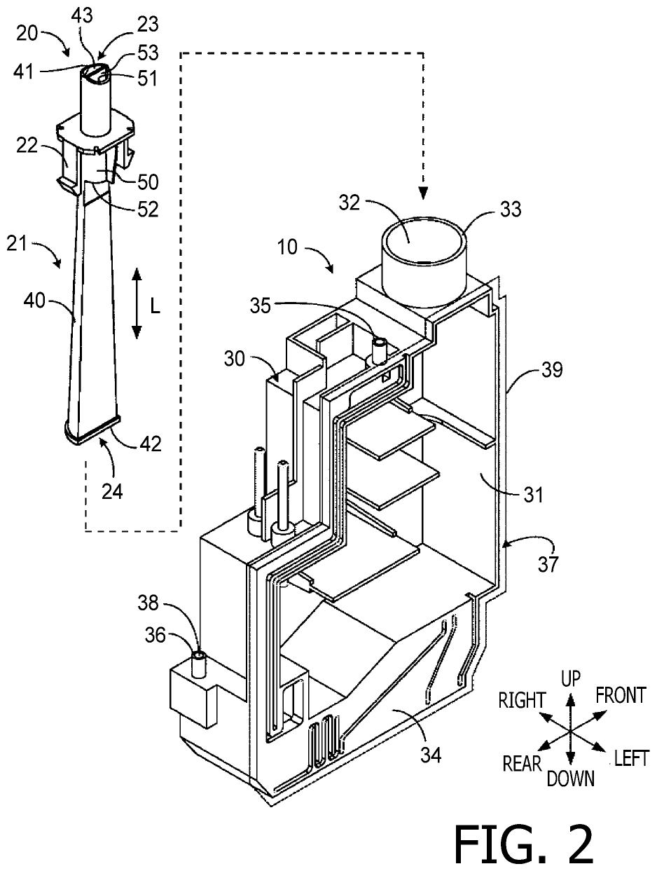

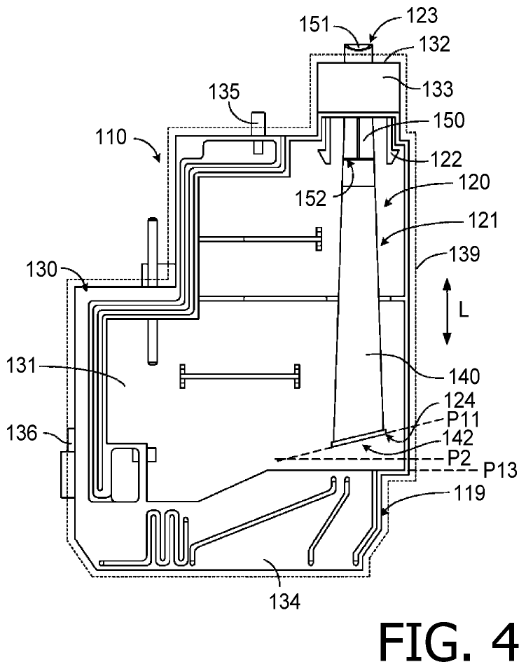

As shown in FIG. 4, the ink tank 110 includes an ink tank main body 130 and an ink injection cylinder 120. The ink injection cylinder 120 may or may not be separable from the ink tank main body 130. The ink tank main body 130 mainly includes an ink storage chamber 131, an ink injecting part 133, an ink injection port 132, buffer chambers 134, an ink supplying part 135, and an air communicating part 136. The buffer chamber 134 are located below the ink storage chamber 131, and communicate with the ink storage chamber 131 through not-shown thin channels. The air communicating part 136 is provided at the top of the buffer chambers 134 and has a passage therein communicating with the buffer chambers 134. An opening at one end of a not-shown air communication tube may be connected to the air communicating part 136, and an opening at another end of the atmosphere communication tube may be disposed near the ink injecting part 133. With this configuration, the air communicating part 136 can communicate with outside the ink tank main body 130 through the opening of the other end portion of the air communication pipe. The ink tank 110 of the first embodiment has the same structure as the ink tank 10 shown in FIG. 2.

The ink tank main body 130 may include a resin member and a film 139. Specifically, a resin housing 119 serving as the main of the ink tank main body 130 may be formed in a mold by injection molding method using resin material. The resin housing 119 is provided with hollow chambers used to form internal spaces of the ink storage chamber 131 and the buffer chambers 134. Since each hollow chamber have an opening on one side, it is easy to remove the resin housing 119 from the mold.

Thereafter, the film 139 is coupled to the resin housing 119 using a coupling method such as adhesion to cover the opening on one side of the hollow chamber, thereby forming a passage for making the ink storage chamber 131 communicate with a plurality of buffer chambers 134. Another not-shown film is coupled to another side of the resin housing 119 to form the ink storage chamber 131.

The ink injection cylinder and the ink tank according to the first embodiment of the present disclosure will be described in detail below with reference to FIGS. 4 to 8.

### First Embodiment

FIG. 4 shows the ink injection cylinder 120 according to the first embodiment of the present disclosure. The ink injection cylinder 120 has a main body 121 extending along the longitudinal direction L, and the main body 121 has a first end 123 and a second end 124 opposite the first end 123 along the longitudinal direction L.

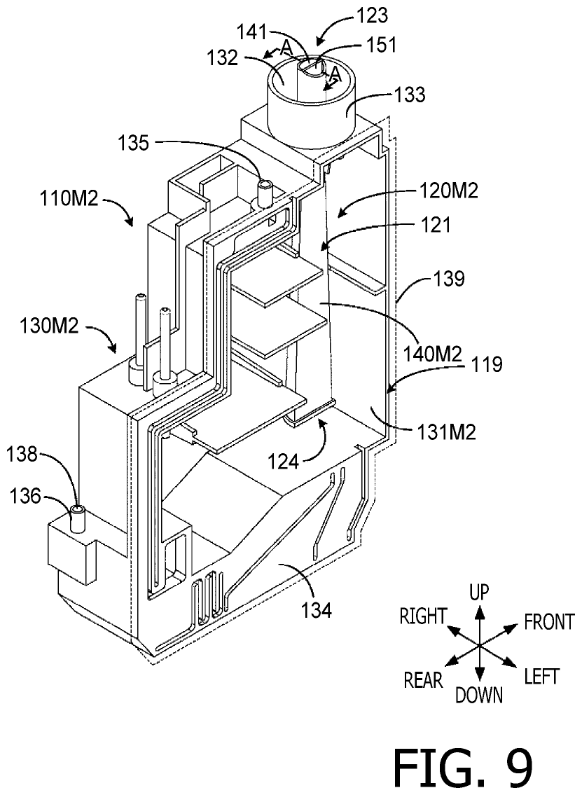

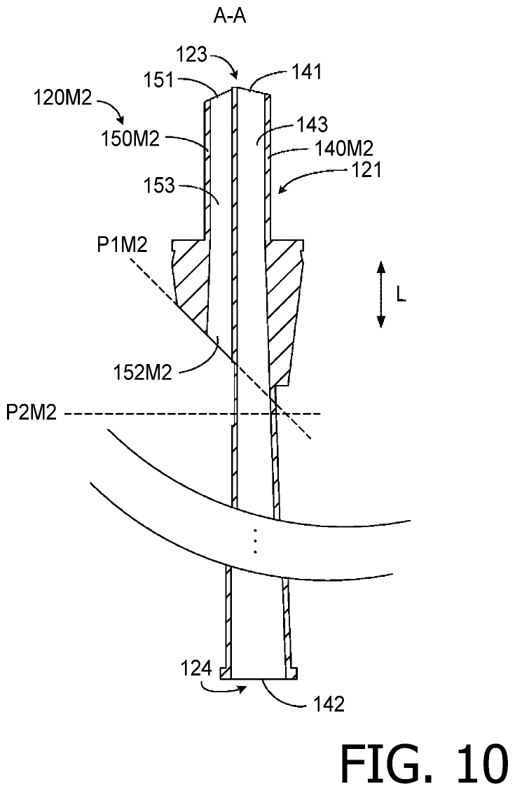

As shown in FIG. 4, the main body 121 includes a first flow path tube 140 and a second flow path tube 150. The first flow path tube 140 extends along the longitudinal direction L and has a first opening 141 located at the first end 123, a second opening 142 located at the second end 124, and a first flow path 143 formed between the first opening 141 and the second opening 142. It should be noted that the first opening 141 is not shown in the drawings showing the first embodiment, but the first openings 141 in other embodiments which may have different shapes but have the same function are shown in other drawings (e.g., FIG. 9) showing other embodiments. Similarly, the first flow path 143 is not shown in the drawings showing the first embodiment, but the first flow paths 143 in other embodiments which may have different shapes but have the same function are shown in other drawings (e.g., FIG. 10) showing other embodiments. As is apparent from the drawings, in the longitudinal direction L, a distance from the first opening 141 to the first end 123 is shorter than a distance from the second opening 142 to the first end 123. In other words, the first flow path tube has the first opening 141 on one side in the longitudinal direction L (in the drawings, on the upper side), and the second opening 142 on another side in the longitudinal direction (in the drawing, on the lower side).

As shown in FIG. 4, the first end 123 can be understood to be an end of the first flow path tube 140 where the first opening is formed, whereby the distance from the first opening to the first end 123 is 0. Preferably, an internal cross-sectional area of the first flow path tube 140 may gradually increase from the first end 123 to the second end 124 along the longitudinal direction L. In other words, the internal cross-sectional area of the first flow path tube 140 may gradually increase from the first opening 141 to the second opening 142 along the longitudinal direction L. Thus, in the ink injection process, ink smoothly flows from the first end 123 to the second end 124 into the ink storage chamber 131 though the first flow path tube 140.

The ink injection cylinder 120 further includes mounts 122 provided outside the main body 121. When the ink injection cylinder 120 is mounted to the ink tank main body 130 shown in FIG. 4, the second end 124 of the main body 121 of the ink injection cylinder 120 extends through the ink injection port 132 of the ink tank main body 130 and enters the ink storage chamber 131.

A not-shown engaging part is provided to the ink tank main body 130. When the mounts 122 engage with the engaging part, the ink injection cylinder 120 is fixed and mounted to the ink tank main body 130.

In the present embodiment, Each mount 122 has a hook projecting outward, and the engaging part is a rib corresponding to the shape of the mounts 122. The mounts 122 and the engaging part engage with each other by hooking the hook to the rib. In other embodiments, the mount 122 may be configured to engage with the engaging part in other ways. For example, a buckle-type engagement may be employed.

Similarly, the second flow path tube 150 extends along the longitudinal direction L and has a third opening 151 at the first end 123, a fourth opening 152, and a second flow path 153 formed between the third opening 151 and the fourth opening 152. It should be noted that the second flow path 153 is not shown in the drawings showing the first embodiment, but the second flow paths 153 in other embodiments which may have different shapes but have the same function are shown in other drawings (e.g., FIG. 10) showing other embodiments. As is apparent from the drawings, in the longitudinal direction L, a distance from the third opening 151 to the first end 123 is shorter than a distance from the fourth opening 152 to the first end 123. In other words, the second flow path tube 150 has the third opening 151 on the one side in the longitudinal direction L, and the fourth opening 152 on the other side in the longitudinal direction L. Additionally, in the longitudinal direction L, a distance from the fourth opening 152 to the first end 123 is shorter than the distance from the second opening 142 to the first end 123. In other words, the second flow path tube 150 or the second flow path 153 is shorter than the first flow path tube 140 or the first flow path 143. Furthermore, a distance from the first opening 141 to the third opening 151 is shorter than a distance from the second opening 142 to the fourth opening 152.

In the ink injection process, ink enters the ink storage chamber 131 through the first flow path tube 140, and the “gas-liquid replacement” process stops when the fourth opening 152 is completely blocked by the ink. Since the second flow path tube 150 is shorter than the first flow path tube 140 and the distance from the fourth opening 152 to the first end 123 is shorter than the distance from the second opening 142 to the first end 123, sufficient amount of ink can be injected into the ink storage chamber 131.

The first flow path tube 140 and the second flow path tube 150 may be provided as a single member molded integrally or as separate members.

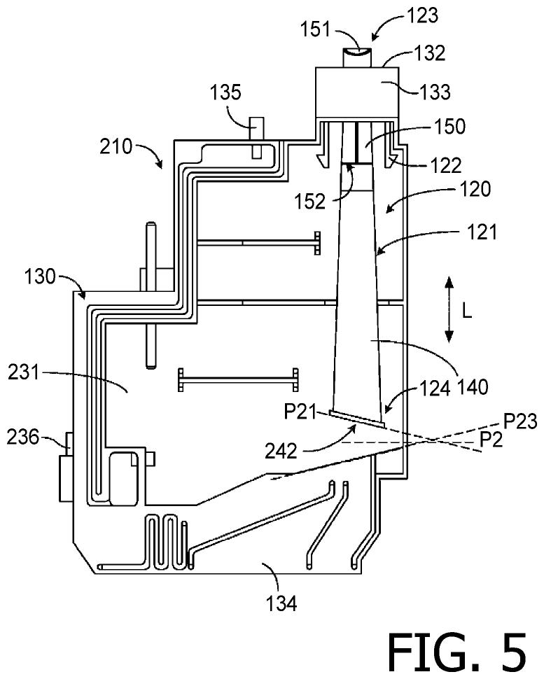

A virtual plane P11 on which at least a portion of an end face of the first flow path tube 140 where the second opening 142 is formed lies intersects with a virtual plane P2 orthogonal to the longitudinal direction L. Specifically, the end face on which the second opening 142 is formed is on an inclined plane shown in FIG. 4, and every portion of the second opening 142 on of the end face is on one plane. The end face on which the second opening 142 is formed may also be on another inclined plane such as the one shown in FIG. 5.

After the ink injection cylinder 120 is mounted to the ink tank main body 130, a mouth of the ink bottle can be inserted into the ink injecting part 133 of the ink tank main body 130, the mouth of the bottle covering the top end of the ink injection cylinder 120, and the first opening and third opening 151 are used to make the ink storage chamber 131 and the ink bottle communicate with each other. The ink injection cylinder 120 causes a “gas-liquid displacement” similar to that described in the background art. In order to simplify the description, the detailed description of the “gas-liquid displacement” will not be repeated here.

Referring still to FIG. 4, a plane P13 including a bottom wall of the ink storage chamber 131 located below the second opening 142 is parallel to the virtual plane P2 orthogonal to the longitudinal direction L. Therefore, by making the end face on which the second opening 142 is formed inclined, a space for fluid flowing in the ink storage chamber 131 is increased, and thus the formation of the meniscus at the second opening 142 can be suppressed and the temporary stop of ink injection during the ink injection process can be prevented.

Modification 1

FIG. 5 shows an ink tank 210 according to Modification 1 of the first embodiment of the present disclosure.

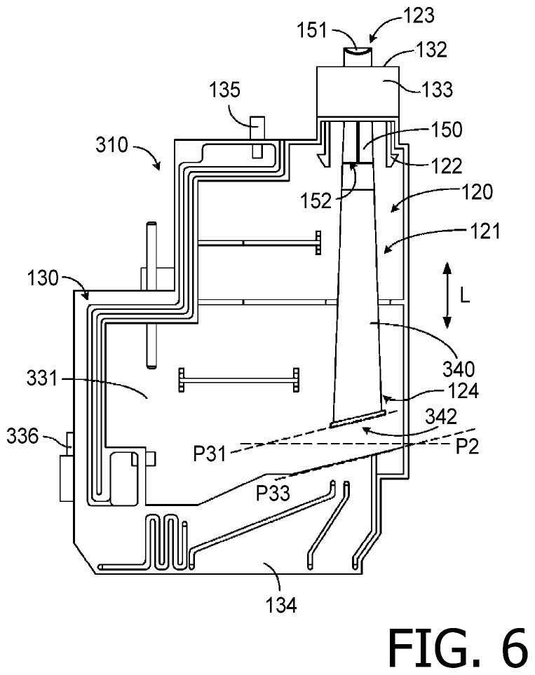

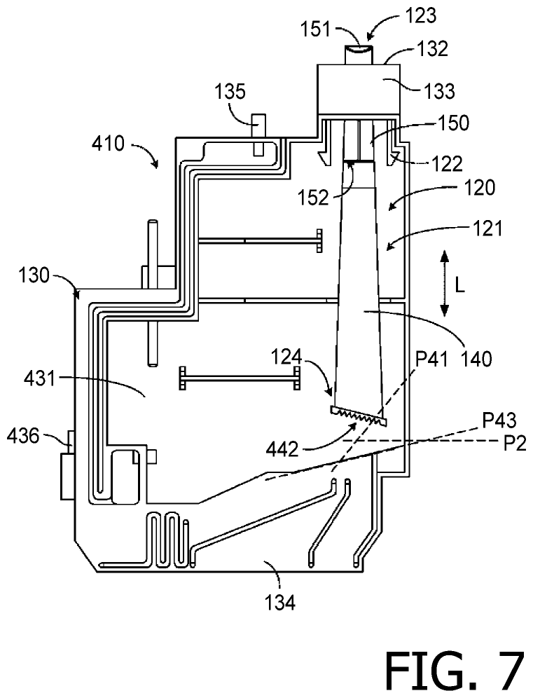

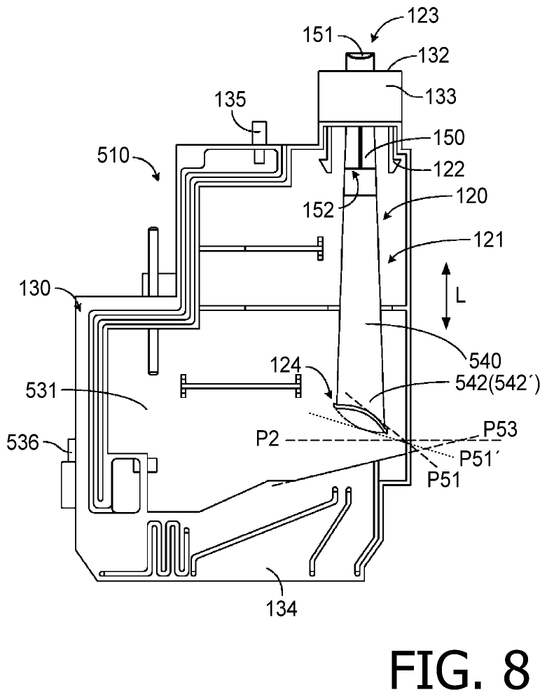

The ink tank 210 of Modification 1 has substantially the same structure as the ink tank 110 of the first embodiment except for the structures of the second opening 242 and the bottom portion of the ink storage chamber 231. Therefore, in order to simplify the description, structures having the same functions as those of the first embodiment will not be described in detail again, and only different technical features will be described. Structures having the same functions as those of the second embodiment and not appearing in the description of the present modification are denoted by the same reference numerals as those of the first or second embodiment. The same applies to Modification 2 to Modification 4. Furthermore, in the ink tank 210 of Modification 1 shown in FIG. 5, the ink tank 310 of Modification 2 shown in FIG. 6, the ink tank 410 of Modification 3 shown in FIG. 7 and the ink tank 510 of Modification 4 shown in FIG. 8, the film is not shown.

As shown in FIG. 5, since a virtual plane P21 on which an end face on which a second opening 242 is formed lies is an inclined plane, every portion of an end face of the second opening 242 is on the virtual plane P21, and a portion of the end face of the second opening 242 close to an air communicating part 236 is located higher than a portion of the end face of the second opening 242 away from the air communicating part 236. Furthermore, a plane P23 located below the second opening 242 including a bottom wall of an ink storage chamber 231 located below the second opening 242 intersects with the virtual plane P2 orthogonal to the longitudinal direction L. As shown in FIG. 5, a height of a surface of the plane P23 decreases toward the air communicating part 236. Therefore, in the ink storage chamber 231, there is plenty of space between the second opening 242 and the bottom wall below the second opening 242, and when fluid flows out from the second opening 242 into the ink storage chamber 231, the fluid can flow away from the second opening 242 into the ink storage chamber 231 spontaneously at a high flow rate. Furthermore, the formation of a meniscus at the second opening 242 can be suppressed. Therefore, the temporary stop of injection of ink during the ink injection process can be prevented.

Modification 2

FIG. 6 shows an ink tank 310 according to Modification 2 of the first embodiment of the present disclosure.

As shown in FIG. 6, since a virtual plane P31 on which an end face to which a second opening 342 is formed lies is an inclined plane, every portion of an end face of the second opening 342 is entirely within the virtual plane P31, and a portion of the end face of the second opening 342 close to an air communicating part 336 is located lower than a portion away from the air communicating part 336. The virtual plane P31 on which the end face to which the second opening 342 is formed lies intersects with the plane P2 orthogonal to the longitudinal direction L.

Furthermore, as shown in FIG. 6, a plane P33 including a bottom wall of an ink storage chamber 331 located below the second opening 142 is parallel to the virtual plane P31 on which at least a portion of an end face of a first flow path tube 340 where the second opening 342 is formed lies, and the plane P33 on which the portion of the bottom wall of the ink storage chamber 331 located below the second opening 342 lies and the virtual plane P31 on which the end face to which the second opening 342 is formed lies intersect with the plane P2 orthogonal to the longitudinal direction L. Therefore, a height of a surface of the plane P33 decreases toward the air communicating part 336. In this manner, when fluid flows out from the second opening 342 into the ink storage chamber 331, the fluid can flow away from the second opening 342 into the ink storage chamber 331 spontaneously at a high flow rate. Furthermore, the formation of a meniscus at the second opening 342 can be suppressed. Therefore, the temporary stop of injection of ink during the ink injection process can be prevented.

Modification 3

FIG. 7 shows an ink tank 410 according to Modification 3 of the first embodiment of the present disclosure.

The difference between the ink tank 410 according to Modification 3 and the ink tank 210 according to Modification 1 is that, in the ink tank 410, an end face forming a second opening 442 has a saw-tooth shape.

As shown in FIG. 7, a plane on which at least a portion of an end face of the saw-tooth shaped surface lies represents a plane on which both sides of a V-shape lies. In other words, in the view shown in FIG. 7, a portion of an end face of the saw-tooth shaped surface is in a V-shape. A virtual plane P41 shown in FIG. 7 on which one side of the V-shape lies represents a plane on which a portion of the end face of the saw-tooth shaped surface lies. The virtual plane P41 intersects with a plane P2 orthogonal to the longitudinal direction L.

Referring still to FIG. 7, a plane P43 on which a portion of a bottom wall of an ink storage chamber 431 located below the second opening 442 intersects with the plane P2 perpendicular to the longitudinal direction L. A height of a surface of the plane P43 gradually decreases toward an air communicating part 436. As a result, when fluid flows out from the second opening 442 into the ink storage chamber 431, the fluid can flow away from the second opening 442 into the ink storage chamber 431 spontaneously at a high flow rate, and thus the formation of a meniscus at the second opening 442 can be suppressed. Furthermore, since the end face of the saw-tooth shaped surface can promote the disturbance of the fluid, the flow of the fluid can further be made smooth and the formation of the meniscus can further be suppressed, and thus the temporary stop of injection of ink during the ink injection process can be prevented.

Modification 4

FIG. 8 shows an ink tank 510 according to Modification 4 of the first embodiment of the present disclosure.

The difference between the ink tank 510 of Modification 4 and the ink tank 410 of Modification 3 is that, in the ink tank 510, an end face on which a second opening 542 is formed is a curved surface. In Modification 4, the end face of a first flow path tube 540 where the second opening 542 is formed is a recessed curved surface. This curved surface that can be seen in FIG. 8 is a recessed smooth arc with a continuous curvature. The curved surface can also be said to be a series of recessed portions. A dashed line tangent to the smooth arc in FIG. 8 representing an arbitrary virtual plane P51 on which the recessed portion lies intersects with the virtual plane P2 orthogonal to the longitudinal direction L. In another embodiment, an end face on which a second opening 542′ is formed may be a projected curved surface. In this case, as with Modification 4, a dashed line tangent to the smooth arc in FIG. 8 representing an arbitrary virtual plane P51′ on which the projected curved surface lies intersects with the virtual plane P2 orthogonal to the longitudinal direction L. In order to avoid confusion, in FIG. 8, the virtual plane P51 is represented by a broken line, and the virtual plane P51′ and the projected curved surface (representing the second opening 542′) are represented by dotted lines.

Referring still to FIG. 8, a plane P53 on which a portion of a bottom wall of an ink storage chamber 531 located below the second opening 542 lies intersects with the virtual plane P2 orthogonal to the longitudinal direction L. A height of a surface of the plane P53 gradually decreases toward an air communicating part 536. As a result, when fluid flows out from the second opening 542 into the ink storage chamber 531, the fluid can flow away from the second opening 542 into the ink storage chamber 531 spontaneously at a high flow rate, and thus the formation of a meniscus at the second opening 542 can be suppressed.

When the fluid flows out from the end face on which the second opening 542 of a first flow path tube 540 is formed, since the end face of the curved surface can promote the disturbance of fluid, the flow of the fluid can further be made smooth and the formation of the meniscus can further be suppressed, and thus the temporary stop of injection of ink during the ink injection process can be prevented.

### Second Embodiment

FIG. 9 is a perspective view of an ink tank 110M2 after an ink injection cylinder 120M2 according to the second embodiment of the present disclosure is mounted to an ink tank main body 130M2. FIG. 10 is a cross-sectional view of the ink injection cylinder 120M2 shown in FIG. 9 cut along line A-A, and shows the ink injection cylinder 120M2 according to the second embodiment of the present disclosure. In order to simplify the description, structures having the same functions as those of the first embodiment will not be described in detail again, and only different technical features will be described. Structures having the same functions as those of the first embodiment and not appearing in the description of the present embodiment are denoted by the same reference numerals as those of the first embodiment.

A first flow path tube 140M2 and a second flow path tube 150M2 are integrally molded, and a virtual plane P1M2 (shown by a broken line in FIG. 10) on which at least a portion of an end face of the second flow path tube 150M2 where a fourth opening 152M2 is formed intersects with a virtual plane P2M2 (shown by a broken line in FIG. 10) orthogonal to the longitudinal direction L. Specifically, as shown in FIG. 10, since the virtual plane P1M2 on which the end face of the fourth opening 152M2 is inclined with respect to the longitudinal direction L, that is, since the end face of the fourth opening 152M2 is in the inclined plane shown in FIG. 10, it can be understood that every portion of the end face of the fourth opening 152M2 is on one plane.

As described above, the first flow path tube 140M2 and the second flow path tube 150M2 are integrally molded, and the virtual plane P1M2 on which at least a portion of the end face of the second flow path tube 150M2 where the fourth opening 152M2 is formed intersects with the plane P2M2 orthogonal to the longitudinal direction L. Therefore, a space for fluid flowing in an ink storage chamber 131M2 is increased and the formation of the meniscus at the fourth opening 152M2 can be suppressed. As a result, the flow of the fluid within the second flow path tube 150M2 can further be made smooth and thus the temporary stop of injection of ink during the ink injection process can be prevented.

Modification 1

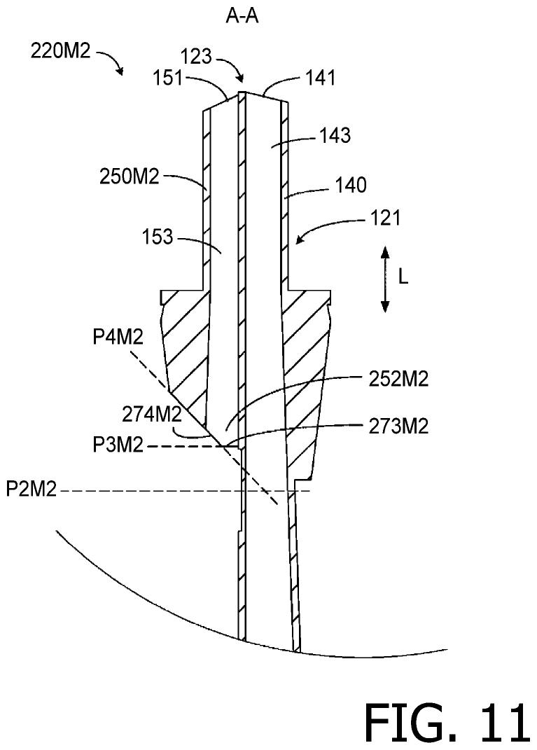

FIG. 11 is a partial cross-sectional view of an ink injection cylinder 220M2 according to Modification 1 of the second embodiment of the present disclosure.

Except for the structure of the fourth opening 252M2, the ink injection cylinder 220M2 of Modification 1 has substantially the same structure as the ink injection cylinder 120M2 of the second embodiment. Therefore, in order to simplify the description, structures having the same functions as those of the second embodiment will not be described in detail again, and only different technical features will be described. Structures having the same functions as those of the second embodiment and not appearing in the description of the present modification are denoted by the same reference numerals as those of the first or second embodiment. The same applies to the ink injection cylinders of Modifications 2 to 4.

As shown in FIG. 11, an end face of the fourth opening 252M2 includes a first end face portion 273M2 and a second end face portion 274M2, and a virtual plane P3M2 on which the first end face portion 273M2 lies is orthogonal to the longitudinal direction L, and a virtual plane P4M2 on which the second end face portion 274M2 lies intersects with a plane P2M2 orthogonal to the longitudinal direction L.

When fluid flows out of the end face of a second flow path tube 250M2 where the fourth opening 252M2 is formed and enters the second flow path tube 250M2 through the fourth opening 252M2, since the flow of the fluid further becomes smooth by the fluctuation of the flow rate of the fluid at the end face, and since the formation of the meniscus is suppressed, the temporary stop of injection of ink during the ink injection process can be prevented.

In Modification 1, only one first end face portion 273M2 and one second end face portion 274M2 are provided, and the first end face portion 273M2 and the second end face portion 274M2 are connected to each other. The present disclosure does not limit the presence or absence of other end face portions in front of the first end face portion 273M2 and the second end face portion 274M2. In other embodiments, a plurality of first end face portions 273M2 and second end face portions 274M2 may be provided, and the first end face portions 273M2 and the second end face portions 274M2 may be alternately and sequentially connected to form an end face forming the fourth opening 252M2 of the second flow path tube 250M2.

Modification 2

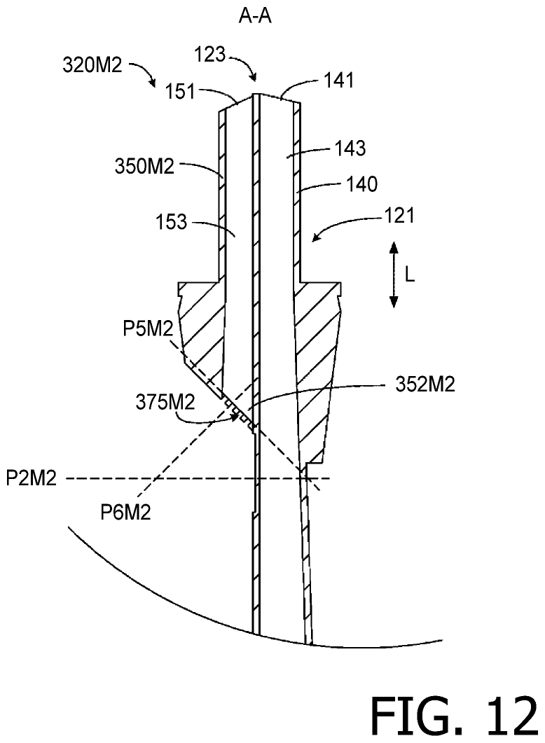

FIG. 12 is a partial cross-sectional view of an ink injection cylinder 320M2 according to Modification 2 of the second embodiment of the present disclosure.

In Modification 2, a groove part 375M2 is formed on an end face of a second flow path tube 350M2 where a fourth opening 352M2 is formed, and a virtual plane P5M2 where a bottom wall of the groove part 375M2 lies and/or a virtual plane P6M2 where a side wall of the groove part 375M2 lies intersect with the plane P2M2 orthogonal to the longitudinal direction L. The groove part 375M2 can be understood as follows. The end face of the second flow path tube 350M2 on which the fourth opening 352M2 is formed has a portion recessed toward the inside of the end face, that is, the end face has the groove part 375M2. As shown in FIG. 12, a plurality of groove parts 375M2 are formed on the end face of the second flow path tube 350M2 where the fourth opening 352M2 is formed, and this end face is formed by connecting the groove parts 375M2 to each other. An inner wall of each groove part 375M2 is formed of two side walls and one bottom wall being connected to each other. The groove part 375M2 may be a right-angled recess. As shown in FIG. 12, the virtual plane P5M2 where the bottom wall of the groove part 375M2 lies is orthogonal to the virtual plane P6M2 where the side wall lies. As a matter of course, one integrated body having the plurality of groove parts 375M2 on the end face connected to each other may also be referred to as one groove part. This is because even in such a structure, this end face is recessed toward the inside.

When fluid flows out of the end face of a second flow path tube 350M2 where the fourth opening 352M2 is formed and enters the second flow path tube 350M2 through the fourth opening 352M2, since the flow of the fluid further becomes smooth by the fluctuation of the flow rate of the fluid at the end face, and since the formation of the meniscus is suppressed, the temporary stop of injection of ink during the ink injection process can be prevented.

Modification 3

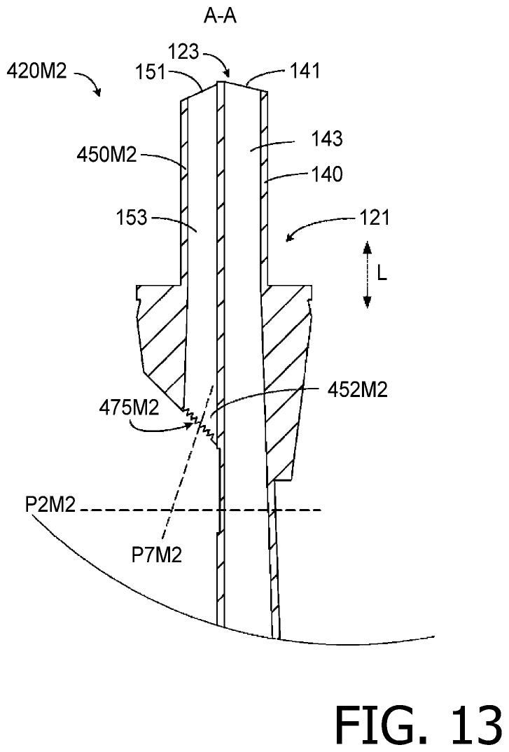

FIG. 13 is a partial cross-sectional view of an ink injection cylinder 420M2 according to Modification 3 of the second embodiment of the present disclosure.

In Modification 3, a groove part 475M2 is formed on an end face of a second flow path tube 450M2 where a fourth opening 452M2 is formed, and the groove part 475M2 has a saw-tooth shape. The saw-tooth shaped groove part 475M2 will be described while regarding a portion where the end face on which the fourth opening 452M2 is formed lies and recessed toward the inside as one unified body. It may also be said that the end face on which the fourth opening 452M2 is formed has a plurality of groove parts 475M2, and each groove part 475M2 is a V-shaped recess.

Referring to FIG. 13, planes on which side walls of the groove part 475M2 are present may be understood as planes on which two sides of the V-shape are present. FIG. 13 shows that a virtual plane P7M2 on which one side of the V-shape lies is a plane on which the side wall of the groove part 475M2 lies, and the plane intersects with the virtual plane P2M2 orthogonal to the longitudinal direction L.

When fluid flows out of the end face of the second flow path tube 450M2 where the fourth opening 452M2 is formed and enters the second flow path tube 450M2 through the fourth opening 452M2, since the flow of the fluid further becomes smooth by the fluctuation of the flow rate of the fluid at the end face, and since the formation of the meniscus is suppressed, the temporary stop of injection of ink during the ink injection process can be prevented.

Modification 4

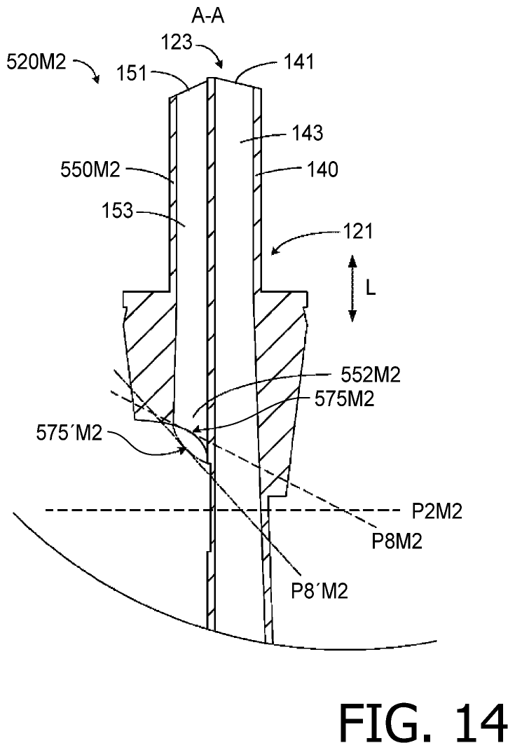

FIG. 14 is a partial cross-sectional view of an ink injection cylinder 520M2 according to Modification 4 of the second embodiment of the present disclosure.

In Modification 4, a groove part 575M2 is formed on an end face of a second flow path tube 550M2 where a fourth opening 552M2 is formed, and the groove part 575M2 has a curved surface. As can be clearly seen in FIG. 14, the groove part 575M2 is a smooth arc recessed toward the inside, and the arc has a continuous curvature. The groove part 575M2 has a plurality of portions recessed toward the inside and connected to each other, whereby a plane P8M2 on which an arbitrary one of the recessed portions lies is represented by a broken line tangent to the smooth arc in FIG. 14. The broken line representing the virtual plane P8M2 intersects with the virtual plane P2M2 orthogonal to the longitudinal direction L. In other embodiments, the end face of the second flow path tube 550M2 where the fourth opening 552M2 is formed may have a projecting part 575′M2, and the projecting part 575′M2 may have a curved surface. For the same reason, a plane P8′M2 on which an arbitrary one of projecting portions protruding outward lies is represented by a broken line tangent to a smooth arc in FIG. 14. The broken line representing the virtual plane P8′M2 intersects with the virtual plane P2M2 orthogonal to the longitudinal direction L. In order to avoid confusion, in FIG. 14, the virtual plane P8M2 is represented by a broken line, and the virtual plane P8′M2 and the projecting part 575′M2 are represented by a dashed line.

As described above, in Modification 4, a space inside the ink storage chamber for fluid to flow is increased, the flow of the fluid further becomes smooth by the fluctuation of the flow rate of the fluid at the end face, and the formation of the meniscus is suppressed. Therefore, the temporary stop of injection of ink during the ink injection process can be prevented.

### Third Embodiment

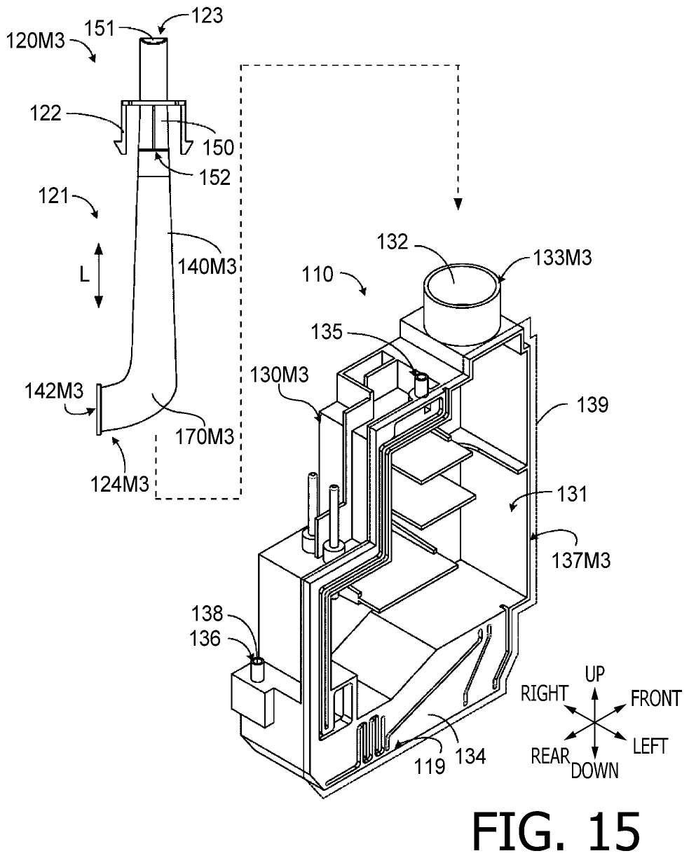

FIG. 15 shows an ink injection cylinder 120M3 according to a third embodiment of the present disclosure. In order to simplify the description, structures having the same functions as those of the first embodiment will not be described in detail again, and only different technical features will be described. Structures having the same functions as those of the first embodiment and not appearing in the description of the present embodiment are denoted by the same reference numerals as those of the first embodiment.

In order to avoid the formation of the meniscus at a second opening 142M3, the second opening 142M3 is provided to a first flow path tube 140M3 to open laterally. Specifically, as shown in FIG. 15, the first flow tube 140M3 includes a curved part 170M3 at a second end 124M3, the second opening 142M3 forms an outlet at an end of the curved part 170M3, and an inner wall of the first flow tube 140M3 has a curved surface at the curved part 170M3. It should be noted that inner walls of the first flow path tube 140M3 at portions other than the curved part 170M3 may also be curved. In the present embodiment, the second opening 142M3 projects from a side wall of the first flow path tube 140M3.

The second opening 142M3 is provided with at least two corners. The second opening 142M3 is surrounded by an arc-shaped wall and vertical walls of the first flow path tube 140M3, thereby having two corners.

In other embodiments in the following description, the second opening may be a quadrilateral opening having four corners.

The second opening 142M3 may be provided such that, in a state where the ink injection cylinder 120M3 is mounted to the ink tank main body 130M3, the second opening 142M3 is open in a direction opposite to a viewing surface 137M3. For example, in FIG. 15, the viewing surface 137M3 is facing forward, and the second opening 142M3 may be open toward the rear side. When injecting ink, the mouth of the ink bottle is inserted into an ink injecting part 133M3 of the ink tank main body 130M3 to cover the top end of the ink injection cylinder 120M3. When ink is injected through the ink injection cylinder 120M3, the “gas-liquid displacement” described in the background art occurs. However, since the second opening 142M3 opens laterally (toward the “rear” side in FIG. 15), a space around the second opening 142M3 is relatively open and thus meniscus is less likely to occur. Therefore, ink can smoothly flow out from the second opening 142M3.

In summary, since the second opening 142M3 is provided to the first flow path tube 140M3 to open laterally, the formation of the meniscus at the second opening 142M3 can be suppressed and thus flow of ink inside the first flow path tube 140M3 can further be made smooth. Therefore, the temporary stop of injection of ink during the ink injection process can be prevented.

Modification 1

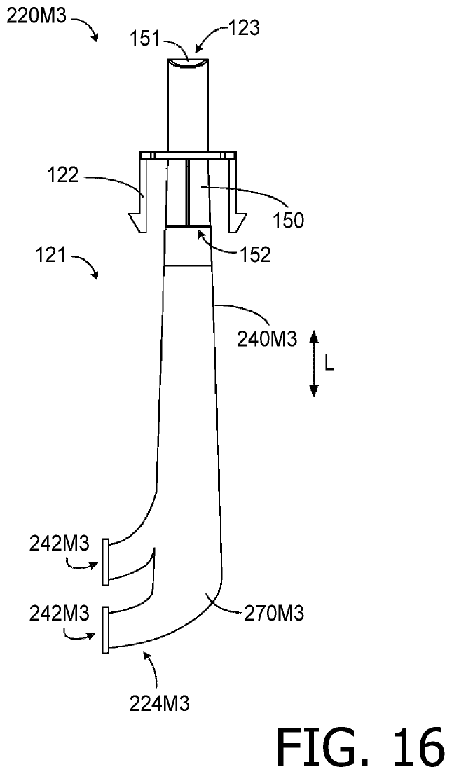

FIG. 16 shows an ink injection cylinder 220M3 according to Modification 1 of the third embodiment of the present disclosure.

Except for the structure at a second end 224M3, the ink injection cylinder 220M3 of Modification 1 has substantially the same structure as the ink injection cylinder 120M3 of the third embodiment. Therefore, in order to simplify the description, structures having the same functions as those of the third embodiment will not be described in detail again, and only different technical features will be described. Structures having the same functions as those of the third embodiment and not appearing in the description of the present modification are denoted by the same reference numerals as those of the first or third embodiment. The same applies to ink injection cylinders of Modifications 2 to 5. As shown in FIG. 16, a first flow path tube 240M3 includes a curved part 270M3 at the second end 224M3, the curved part 270M3 includes two branched flow paths, and the two branched flow paths form two second openings 242M3. The number of branched flow paths may be three or more, and each branched flow path forms the second opening.

The second openings 242M3 opens laterally from the first flow path tube 240M3, and fluid flows in the first flow path tube 240M3 through the plurality of second openings 242M3. That is, since a plurality of branched flow paths through which fluid can flow are provided, the temporary stop of injection of ink during the ink injection process can be prevented, and the ink injection process becomes faster.

Modification 2

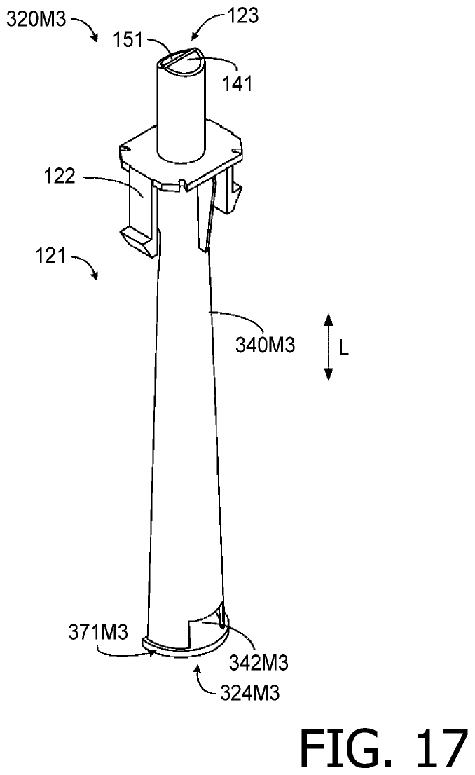

FIG. 17 shows an ink injection cylinder 320M3 according to Modification 2 of the third embodiment of the present disclosure.

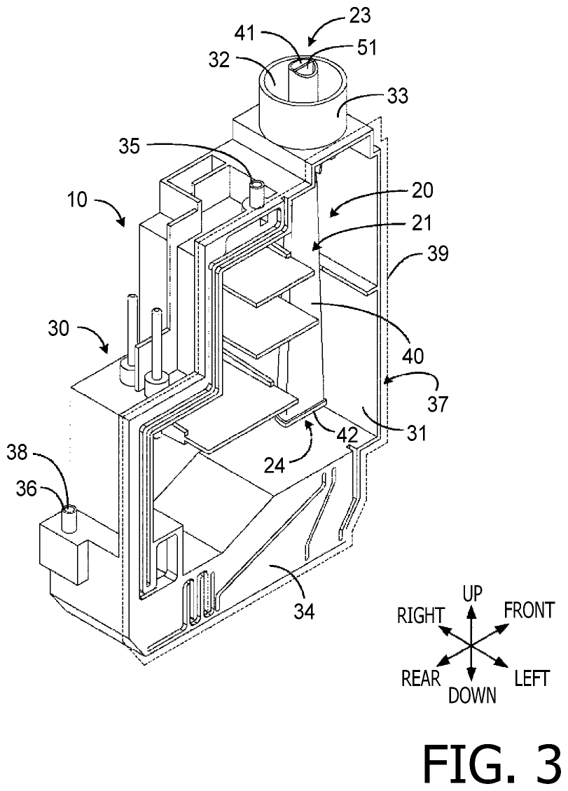

In Modification 2, the first flow path tube 340M3 includes an end wall 371M3 at a second end 324M3, and a second opening 342M3 is provided to a side wall of the first flow path tube 340M3. The second opening 342M3 is formed directly to the side wall of the first flow path tube 340M3, that is, the second opening 342M3 is formed by removing a portion of the side wall of the first flow path tube 340M3. In Modification 2, the second opening 342M3 is on the side wall of the first flow passage tube 340M3 which does not project like the second opening 142 shown in FIG. 3 or the second opening 242 shown in FIG. 4.

As shown in FIG. 17, the second opening 342M3 of Modification 2 communicates with the end wall 371M3. An edge of the side walls of the first flow path tube 340M2 where the second opening 342M2 is formed is connected to the end wall 371M3 and, together with the end wall 371M3, forms an opening through which ink flows. Specifically, the second opening 342M3 has two corners formed on the side wall of the first flow path tube 340M3, and two corners formed at boundaries between the side wall of the first flow path tube 340M3 and the end wall 371.

Since the first flow path tube 340M3 includes the end wall 371M3 at the second end 324M3 and the second opening 342M3 on the side wall of the first flow passage tube 340M3, a space in the ink storage chamber occupied by the ink injection cylinder 320M3 can be saved, a larger amount of ink can be accommodated in the ink storage chamber, and processing of the ink injection cylinder 320M3 can be further simplified.

Modification 3

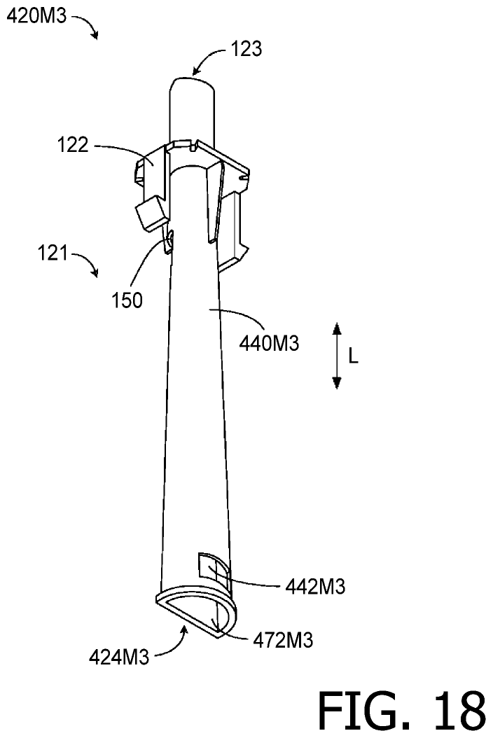

FIG. 18 shows an ink injection cylinder 420M3 according to Modification 3 of the third embodiment of the present disclosure.

In Modification 3, a first flow path tube 440M3 includes a fifth opening 472M3 at a second end 424M3, and the fifth opening 472M3 is open in the longitudinal direction L. A second opening 442M3 is similar to the second opening 142M3 of the third embodiment and communicates with the fifth opening 472M3. By providing the second opening 442M3 to open laterally from the first flow path tube 440 and the fifth opening 472M2 to open in the longitudinal direction L from the first flow path tube 440, fluid can be made to flow between the first flow path tube 440M3 and the ink storage chamber at a higher speed, the occurrence of the meniscus can be suppressed, and the temporary stop of injection of ink during the ink injection process can be avoided.

Modification 4

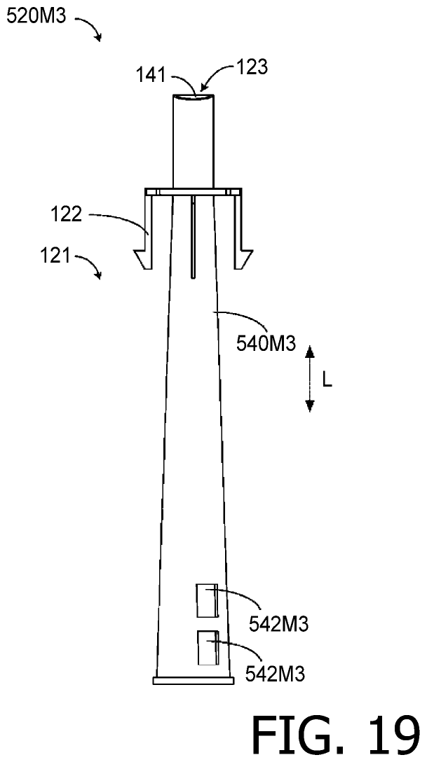

FIG. 19 shows an ink injection cylinder 520M3 according to Modification 4 of the third embodiment of the present disclosure.

In Modification 4, a plurality of second openings 542M3 (two are shown in FIG. 19) are provided. The second openings 542M3 are all provided to a side wall of a first flow path tube 540M3. The plurality of second openings 542M3 are spaced apart along the longitudinal direction L. Preferably, the plurality of second openings 542M3 are aligned along the longitudinal direction L (see FIG. 19). Distances between two adjacent second openings 542M3 in the longitudinal direction L may or may not be the same. The expression “not the same” as used herein means that, among a plurality of intervals formed by the plurality of second openings 542M3, all of them are different, or at least one interval is different from the other intervals. The plurality of second openings 542M3 may not be aligned along the longitudinal direction L.

The ink injection cylinder 520M3 of Modification 4 may have an end wall such as the end wall 371M3 of Modification 2 (see FIG. 17) or an opening such as the fifth opening 472M3 of Modification 3 (see FIG. 18).

Modification 5

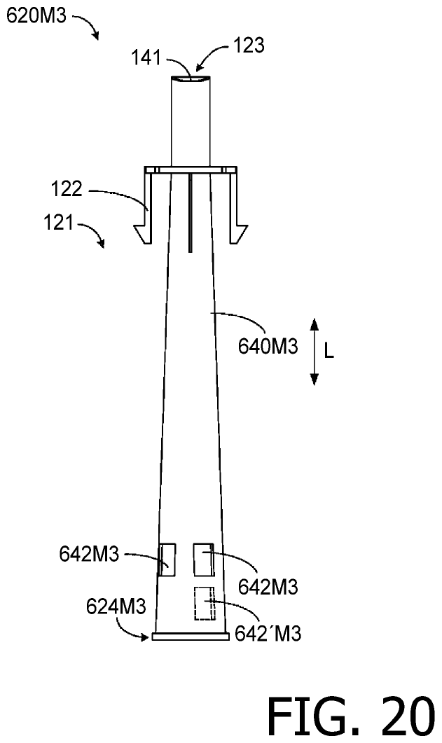

FIG. 20 shows an ink injection cylinder 620M3 according to Modification 5 of the third embodiment of the present disclosure.

In Modification 5, the ink injection cylinder 620M3 has a plurality of second openings 642M3 (two are shown in FIG. 20). The second openings 642 are all provided to a side wall of a first flow path tube 640M3. The plurality of second openings 642M3 are provided at intervals in the circumferential direction. Preferably, distances from a second end 624M3 to the plurality of second openings 642M3 along the longitudinal direction L are the same. More preferably, the plurality of second openings 642M3 are all provided at equal intervals along the circumferential direction. It should be noted that, among the plurality of intervals in the case where the plurality of second openings 642M3 are formed along the circumferential direction, all the intervals may not be the same, or at least one of the plurality of intervals may not be the same as the other intervals. Of course, the distance to the second end 624M3 along the longitudinal direction L of at least one second opening 642′M3 needs not be the same as the distance to the second end 624M3 along the longitudinal direction L of the other second openings 642M3. The distance of the second opening 642M3 or the second opening 642′M3 to the second end 624M3 along the longitudinal direction L may be the shortest distance from a plane on which an end face of the second end 624M3 lies.

The ink injection cylinder 620M3 of Modification 5 may have an end wall such as the end wall 371M3 of Modification 2 (see FIG. 17) or an opening such as the fifth opening 472M3 of Modification 3 (see FIG. 18).

According to the third embodiment, there is provided an ink injection cylinder used for injecting ink into an ink tank having an ink injection port. The ink injection cylinder extends in a longitudinal direction and includes a main body having a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. The second opening opens laterally from the first flow path tube.

The first flow path tube may include a curved part at the second end, the second opening may form an outlet at an end of the curved part, and an inner wall of the first flow path tube may form a curved surface or an inflected surface at the curved part.

The curved part may have a plurality of branched paths, and the plurality of branched paths may form a plurality of the second openings.

The first flow path tube may include an end wall at the second end, and the second opening may be provided to a side wall of the first flow path tube.

The first flow path tube may have a fifth opening at the second end, and the fifth opening may be open in the longitudinal direction.

A plurality of the second openings may be provided, and the plurality of second openings may be provided at intervals along the longitudinal direction or along a circumferential direction of the first flow path tube.

Further, according to the third embodiment, there is provided an ink tank for use in an inkjet printer having a recording engine. The ink tank has an ink tank main body and a film adhered thereto. The ink tank main body includes an ink storage chamber configured to store ink to be supplied to the recording engine, an ink injection port in communication with the ink storage chamber, and any of the ink injection cylinders described above. The ink injection cylinder extends through the ink injection port to the ink storage chamber, and the first opening and the third opening are disposed outside the ink tank main body. The first flow path communicates with the ink storage chamber through the second opening, and the second flow path communicates with the ink storage chamber through the fourth opening.

The tank main body may be provided with a viewing surface used for viewing the liquid surface of ink in the ink storage chamber, and the second opening may be open in a direction opposite to the viewing surface.

Further, according to the third embodiment, there is provided an inkjet printer including a recording engine and any of the ink tanks described above.

### Fourth Embodiment

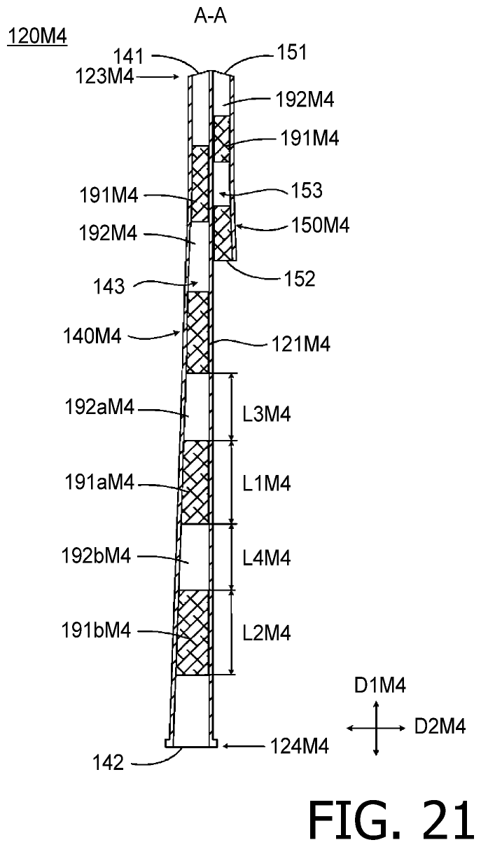

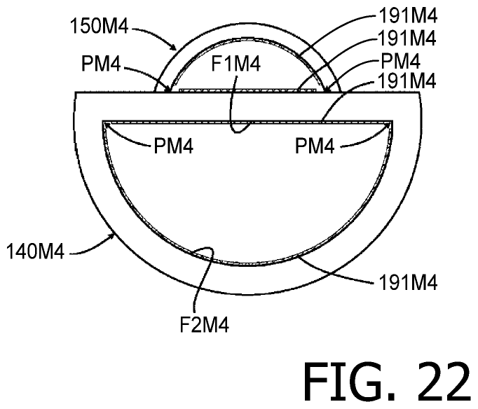

FIGS. 21 and 22 show an ink injection cylinder 120M4 according to a fourth embodiment of the present disclosure. Although not shown in the drawings, mounts similar to those in the other embodiments are molded integrally with a main body 121M4 of the ink injection cylinder 120M4. In order to simplify the description, structures having the same functions as those of the first embodiment will not be described in detail again, and only different technical features will be described. Structures having the same functions as those of the first embodiment and not appearing in the description of the present embodiment are denoted by the same reference numerals as those of the first embodiment.

As shown in FIGS. 21 and 22, first areas 191M4 and second areas 192M4 are provided on the entire inner surfaces of the first flow path tube 140M4 and the second flow path tube 150M4. Shapes and structures of the first flow path tube 140M4 and the second flow path tube 150M4 may be substantially the same. Accordingly, an example of the first flow path tube 140M4 will be described below. The first flow path tube 140M4 may have any shape, and thus its inner surface may have any shape.

In the fourth embodiment, the inner surface has a closed cross-section in a lateral direction D2M4 perpendicular to a longitudinal direction D1M4 and includes no end point. That is, the inner surface is a circumferentially continuous arcuate surface. In this embodiment, the first areas 191M4 and the second areas 192M4 may be arbitrarily provided as required.

In another modification, the inner surface has a closed cross-section along the lateral direction D2M4 perpendicular to the longitudinal direction D1M4 and includes at least one endpoint P. Since the gas-liquid interface ends at the end point PM4, the first areas 191M4 are provided at portions other than the end point PM4 of the cross section. By simplifying the structure in this way, it becomes easier to manufacture the ink injection cylinder. For example, in the fourth embodiment, the first flow path tube 140M4 is a semi-cylinder. As shown in FIG. 22, in the cross-section along the lateral direction D2M4, the inner surface is closed, has a semi-circular shape, and includes two end points PM4. That is, the inner surface includes a flat surface F1M4 extending along the longitudinal direction D1M4 and an arcuate surface F2M4, and the flat surface F1M4 and the arcuate surface F2M4 intersect with each other to form two end lines. The first areas 191M4 are at positions other than these two end points PM4 in the cross-section and, furthermore, is outside areas near the end points PM4. That is, the first areas 191M4 are not provided on end lines where the flat surface F1M4 and the arcuate surface F2M4 intersect with each other and in areas near the end lines.

The first areas 191M4 and the second areas 192M4 all extend along a prescribed direction. At least one of the first areas 191M4 and the second areas 192M4 is provided with an interval along a direction different from the prescribed direction. Preferably, the first areas 191M4 are adjacent to each other and are arranged parallel to the lateral direction D2M4. In this fourth embodiment, the second areas 192M4 extend on the end lines from a first end 123M4 up to a second end 124M4.

Lengths of the first areas 191M4 and the second areas 192M4 along the longitudinal direction D1M4 are substantially the same. If necessary and/or desired, the length along the longitudinal direction D1M4 of at least one of the first areas 191M4 and the second areas 192M4 may be changed. For example, the lengths of either or both the first areas 191M4 and the second areas 192M4 along the longitudinal direction D1M4 may be gradually increased or decreased, or alternately increased and decreased. Specifically, for example, the inner surface includes the first areas 191M4 provided on the upper and lower sides, and a first area 191aM4 on the upper side has a first length L1M4, a first area 191bM4 on the lower side has a second length L2M4, and the first length L1M4 is shorter than second length L2M4. Furthermore, for example, the inner surface includes the second areas 192M4 provided on the upper and lower sides, and a second area 192aM4 on the upper side has a third length L3M4, a second area 192bM4 on the lower side has a fourth length L4M4, and the third length L3M4 is longer than the fourth length L4M4.

All the first areas 191M4 have the same wettability, and all the second areas 192M4 have the same wettability. If necessary and/or desired, the wettability of at least one of the first areas 191M4 and the second areas 192M4 may be changed along the longitudinal direction D1M4. For example, the wettability of at least one of the first area 191M4 and the second area 192M4 may be gradually increased or decreased along the longitudinal direction D1, or may be alternately increased and decreased.

Specifically, the inner surface includes the first areas 191M4 provided on the upper and lower sides and, for example, the wettability of the first area 191aM4 on the upper side may be higher or lower than the wettability of the first area 191bM4 on the lower side. Similarly, the inner surface includes the second areas 192M4 provided on the upper and lower sides and, for example, the wettability of the second area 192aM4 on the upper side may be higher or lower than the wettability of the second area 192bM4 on the lower side.

In the fourth embodiment, the difference in the wettability may be realized by roughness of the inner surface. In the present embodiment, the roughness of the first areas 191M4 is greater than the roughness of the second areas 192M4.

For example, the first areas 191M4 have rough surfaces and the second areas 191M4 have smooth surfaces. Since the ink injection cylinder 120 is manufactured by injection molding using a mold, one method of forming the first areas 191M4 and the second areas 192M4 having different roughness in the ink injection cylinder 120 is to provide areas having different roughness on the surface of the mold that forms the inner surface. Another method of forming the first areas 191M4 and the second areas 192M4 having different roughness in the ink injection cylinder 120M4 is to polish desired areas on the inner surface of the ink injection cylinder 120M4 after molding.

Another method of providing roughness to realize the difference in wettability is to apply a surface coating to the inner surface. In the present embodiment, the surface coating is applied to at least one of the first areas 191M4 and the second areas 192M4. For example, the surface coating may be applied to the first areas 191M4 and may not be applied to the second areas 192M4. The wettability of the first areas 191M4 becomes higher than the wettability of the second areas 192M4 due to the surface coating. The surface coating can be formed on desired areas of the inner surface by applying a liquid agent to the areas after molding the ink injection cylinder 120M4.

Modification 1

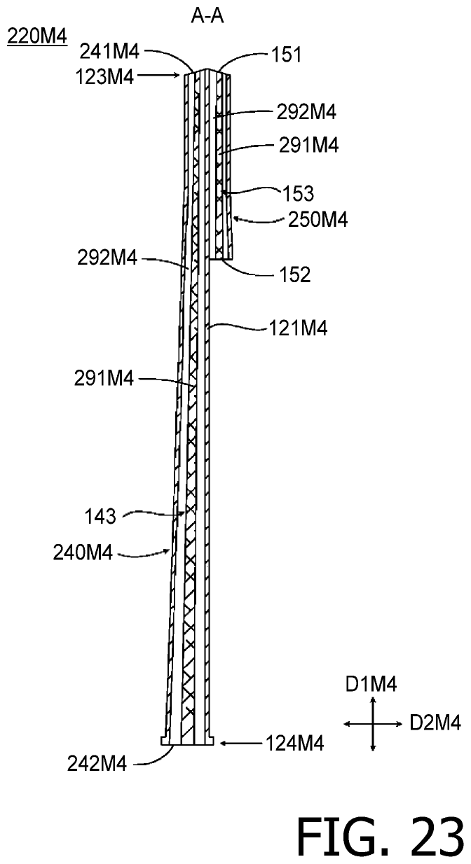

FIG. 23 shows an ink injection cylinder 220M4 according to Modification 1 of the fourth embodiment of the present disclosure. The ink injection cylinder 220M4 of Modification 1 has substantially the same structure as the ink injection cylinder 120M4 of the fourth embodiment except for the first areas and the second areas. Therefore, in order to simplify the description, structures having the same functions as those of the fourth embodiment will not be described in detail again, and only different technical features will be described. Structures having the same functions as those of the fourth embodiment and not appearing in the description of the present modification are denoted by the same reference numerals as those of the first or fourth embodiment.

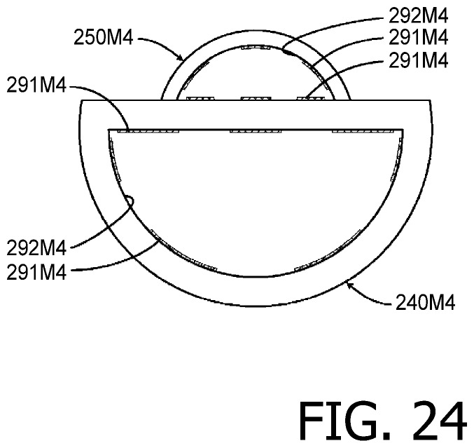

first areas 291M4 and second areas 292M4 are provided on each of inner surfaces of a first flow path tube 240M4 and a second flow path tube 250M4. Referring to the first flow path tube 240M4, the first areas 291M4 and the second areas 292M4 all extend along the longitudinal direction D1M4 (FIG. 23) and are provided at approximately constant intervals along the lateral direction D2M4 (FIG. 24). Preferably, the first areas 291M4 are adjacent to each other and are generally parallel to each other in the longitudinal direction D1M4. At least one of the first areas 291M4 and the second areas 292M4 run through the inner surface. That is, at least one of the first areas 291M4 and the second areas 292M4 extend from a first opening 241M4 to a second opening 242M4. In Modification 1, both the first areas 291M4 and the second areas 292M4 run through the inner surface. The wettability of at least one of the first areas 291M4 and the second areas 292M4 changes along the longitudinal direction D1.

Modification 2

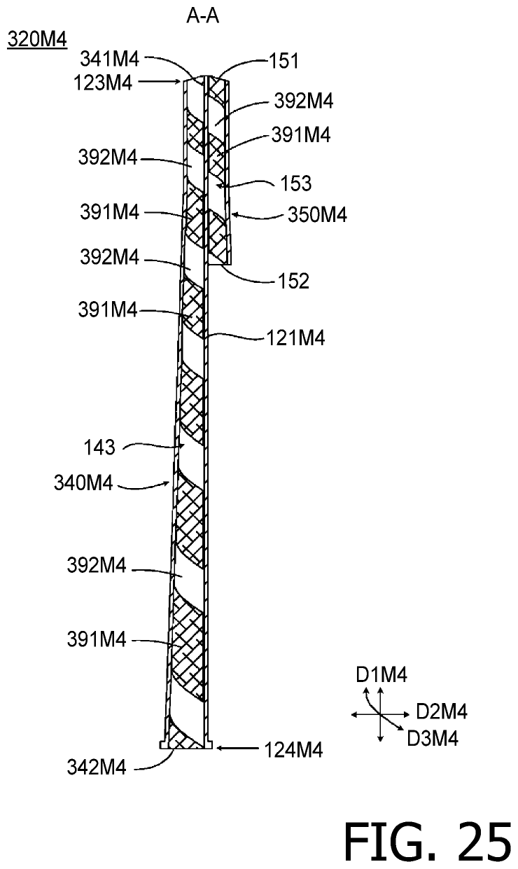

FIG. 25 shows an ink injection cylinder 320M4 according to Modification 2 of the fourth embodiment of the present disclosure. The ink injection cylinder 320M4 of Modification 2 has substantially the same structure as the ink injection cylinder 120M4 of the fourth embodiment except for the first areas and the second areas. Therefore, in order to simplify the description, structures having the same functions as those of the fourth embodiment will not be described in detail again, and only different technical features will be described. Structures having the same functions as those of the fourth embodiment and not appearing in the description of the present modification are denoted by the same reference numerals as those of the first or fourth embodiment.

As shown in FIG. 25, first area 391M4 and second area 392M4 are provided on each of inner surfaces of a first flow path tube 340M4 and a second flow path tube 350M4. Referring to the first flow path tube 340M4, the first area 391M4 and the second area 392M4 both extend along a first direction D3M4 at an angle to the longitudinal direction D1M4 (FIG. 25). The first direction D3M4 is different from the longitudinal direction D1M4 and the lateral direction D2M4. The first area 391M4 and the second area 392M4 are provided at approximately constant intervals along the longitudinal direction D1M4 (FIG. 25). Preferably, at least one of the first area 391M4 and the second area 392M4 is provided in a spiral shape. A length of at least one of the first area 391M4 and the second area 392M4 along the longitudinal direction D1M4 may change along the longitudinal direction D1M4. At least one of the first area 391M4 and the second area 392M4 runs through the inner surface. That is, at least one of the first area 391M4 and the second area 392M4 extends from a first opening 341M4 to a second opening 342M4.

In Modification 2, both the first area 391M4 and the second area 392M4 may be provided in a spiral shape, the lengths of these both the first area 391M4 and the second area 392M4 along the longitudinal direction D1M4 may change along the longitudinal direction D1M4, and both the first area 391M4 and the second area 392M4 may run through the inner surface. As a result, the wettability of at least one of the first area 391M4 and the second area 392M4 changes along the longitudinal direction D1M4.

According to the fourth embodiment, there is provided an ink injection cylinder used for injecting ink into an ink tank having an ink injection port. The ink injection cylinder extends in a longitudinal direction and includes a main body having a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. A first area and a second area are provided on an inner surface of at least one of the first flow path tube and the second flow path tube, and the wettability of the first area is higher than the wettability of the second area.

A cross-section of the inner surface along a lateral direction orthogonal to the longitudinal direction may be closed and may have no end point, or the cross-section of the inner surface along the lateral direction orthogonal to the longitudinal direction may be closed and may have at least one end point, and the first area may be located at portions of the cross-section other than the end point.

The first area and the second area may all extend along a prescribed direction. The prescribed direction may include one of the longitudinal direction, the lateral direction orthogonal to the longitudinal direction, and a first direction at an angle with the longitudinal direction.

At least one of the first area and the second area may be provided with an interval along a direction different from the prescribed direction.

At least one of the first area and the second area may run through the inner surface along the longitudinal direction or the first direction, and/or the first area and the second area may be provided in parallel with each other.

In at least one of the first area and the second area, a size in the longitudinal direction may change along the longitudinal direction, and/or the wettability of at least one of the first area and the second area may change along the longitudinal direction.

At least one of the first area and the second area may be arranged in a spiral shape.

A surface roughness of the first area may be greater than a surface roughness of the second area, and/or a surface coating may be applied to at least one of the first area and the second area.

According to the fourth embodiment, there is further provided an ink tank for use in an inkjet printer having a recording engine. The ink tank has an ink tank main body and a film adhered thereto. The ink tank main body includes an ink storage chamber configured to store ink to be supplied to the recording engine, an ink injection port in communication with the ink storage chamber, and any of the ink injection cylinders described above. The ink injection cylinder extends through the ink injection port to the ink storage chamber, and the first opening and the third opening are disposed outside the ink tank main body. The first flow path communicates with the ink storage chamber through the second opening, and the second flow path communicates with the ink storage chamber through the fourth opening.

According to the fourth embodiment, there is further provided an inkjet printer including a recording engine and any of the above-described ink tanks.

### Fifth Embodiment

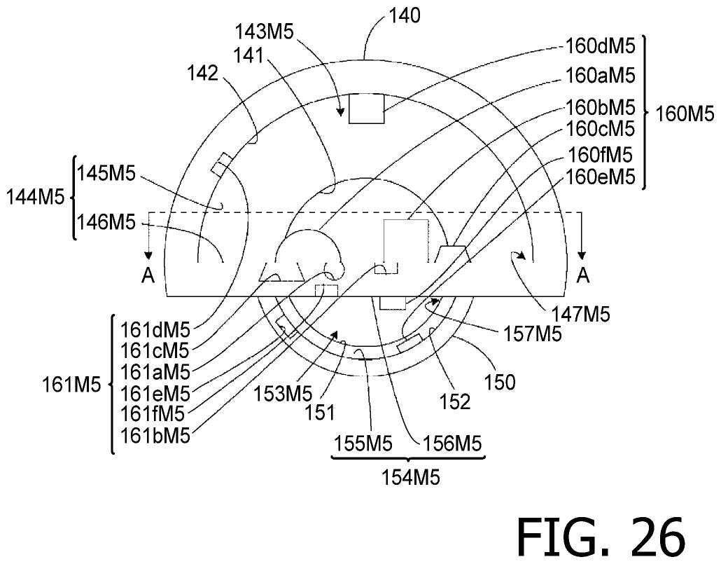

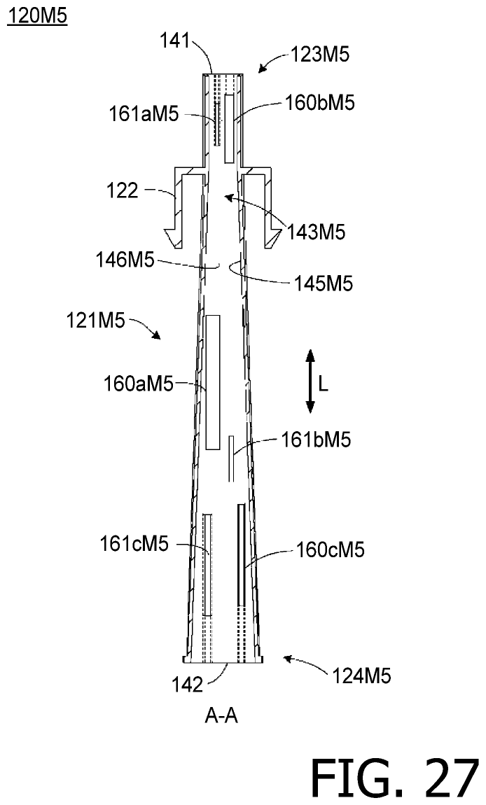

Next, projections 160M5 and recesses 161M5 provided inside a first flow path 143M5 and a second flow path 153M5 of an ink injection cylinder 120M5 according to a fifth embodiment of the present disclosure will be described with reference to FIGS. 26 and 27. In order to simplify the description, structures having the same functions as those of the first embodiment will not be described in detail again, and only different technical features will be described. Structures having the same functions as those of the first embodiment and not appearing in the description of the present embodiment are denoted by the same reference numerals as those of the first embodiment. The projections 160M5 and the recesses 161M5 are provided on inner surfaces 144M5 and 154M5 of the first flow path 143M5 and the second flow path 153M5, respectively, and are projected or recessed with respect to the inner surfaces 144M5 and 154M5, respectively.

Since the projections 160M5 and the recesses 161M5 can suppress the formation of the meniscus in the first flow path 143 and the second flow path 153 through which ink flows, the ink continuously flows.

As shown in FIG. 26, the inner surface 144M5 of the first flow path 143M5 has one curved surface 145M5 and one flat surface 146M5. For example, the curved surface 145M5 may be a portion of a side surface of a truncated cone, a portion of a side surface of a cylinder, or both. Preferably, corners 147M5 are formed at positions where the curved surface 145M5 and the flat surface 146M5 intersect with each other.

Since the corners 147M5 also serve to suppress the formation of the meniscus to some extent, the corners 147M5 exhibit a technical effect similar to that of the projections 160M5 and the recesses 161M5.

The inner surface 154M5 of the second flow path 153M5 has one curved surface 155M5 and one flat surface 156M5. For example, the curved surface 155M5 may be a portion of a side surface of a truncated cone, a portion of a side surface of a cylinder, or both. Similarly to the first flow path 143M5, corners 157M5 are formed at positions where the curved surface 155M5 and the flat surface 156M5 intersect with each other. The corners 157M5 also have the same technical effect as the corners 147M5. The first flow path 143M5 and the second flow path 153M5 may further include a plurality of curved surfaces and/or a plurality of flat surfaces.

Referring still to FIG. 26, the projections 160M5 include projections 160aM5, 160bM5, 160cM5 and 160dM5 provided on the inner surface 144M5 of the first flow path 143M5. The projections 160aM5, 160bM5 and 160cM5 are provided on the flat surface 146M5, and the projection 160dM5 is provided on the curved surface 145M5. The projections 160M5 further include projections 160eM5 and 160fM5 provided on the inner surface 154M5 of the second flow path 153M5. The projection 160eM5 is provided on the curved surface 155M5, and the projection 160fM5 is provided on the flat surface 156M5. The projections may only be provided on either of the curved surface and the flat surface of the inner surface in each of the first flow path and the second flow path, and arbitrary number of projections may be provided. Engineers in this field of technology may make appropriate designs based on actual factors such as the size of the ink injection cylinder and production technology.

The recesses 161M5 include recesses 161aM5, 161bM5, 161cM5 and 161dM5 provided on the inner surface 144M5 of the first flow path 143M5. The recesses 161aM5, 161bM5 and 161cM5 are provided on the flat surface 146M5, and the recess 161dM5 is provided on the curved surface 145M5. The recesses 161M5 further include recesses 161eM5 and 161fM5 provided on the inner surface 154M5 of the second flow path 153M5. The recess 161eM5 is provided on the curved surface 155M5, and the recess 161fM5 is provided on the flat surface 156M5. The recesses may only be provided on either of the curved surface and the flat surface of the inner surface in each of the first flow path and the second flow path, and arbitrary number of recesses may be provided. Engineers in this field of technology may make appropriate designs based on actual factors such as the size of the ink injection cylinder and production technology.

In the first flow path 143M5, a cross-section perpendicular to the longitudinal direction L of the projection 160aM5 has an arcuate shape, that is, a shape formed with a circular arc and a chord corresponding to the circular arc. Cross-sections perpendicular to the longitudinal direction L of the projections 160bM5 and 160dM5 are rectangular. A cross-section perpendicular to the longitudinal direction L of the projection 160cM5 is trapezoidal. Sizes of the projections 160 projecting from the inner surface 144M5 are not the same. Accordingly, the engineer in this technical field may appropriately design the specific shapes and the sizes of the projections 160M5 based on the actual demand. In other embodiments, a plurality of projections may be provided, and at least two of them may have a similarly shaped cross section and/or a similar projection size. Furthermore, the projections may be of any other cross-sectional shapes that can be implemented.

In the second flow path 153M5, cross-sections perpendicular to the longitudinal direction L of the projections 160eM5 and 160fM5 are rectangular. However, the projections 160M5 provided in the second flow path 153M5 may have the same structure as the projections 160M5 in the first flow path 143M5.

In the first flow path 143M5, a cross-section perpendicular to the longitudinal direction L of the recess 161aM5 has an arcuate shape, that is, a shape formed with a circular arc and a chord corresponding to the circular arc. Cross-sections perpendicular to the longitudinal direction L of the recesses 161bM5 and 161dM5 are rectangular. A cross-section perpendicular to the longitudinal direction L of the recess 161cM5 is trapezoidal. Sizes of the recesses 161M5 recessed from the inner surface 144M5 are not the same. Accordingly, the engineer in this technical field may appropriately design the specific shapes and the sizes of the recesses 161M5 based on the actual demand. In other embodiments, a plurality of recesses may be provided, and at least two of them may have a similarly shaped cross-section and/or a similar recess size. Furthermore, the recesses may be of any other cross-sectional shapes that can be implemented.

In the second flow path 153M5, cross-sections perpendicular to the longitudinal direction L of the recesses 161eM5 and 161fM5 are rectangular. However, the recesses 161M5 provided in the second flow path 153M5 may have the same structure as the recesses 161M5 in the first flow path 143M5.

Referring now to FIG. 27, the projections 160M5 and the recesses 161M5 provided on the flat surface 146M5 of the inner surface 144M5 of the first flow path 143M5 are shown. The projections 160aM5, 160bM5 and 160cM5 and the recesses 161aM5, 161bM5 and 161cM5 all extend along the longitudinal direction L. However, installation positions (e.g., distances from the first end 123M5), lengths along the longitudinal direction L and widths of the projections 160aM5, 160bM5 and 160cM5 are not the same. Similarly, installation positions (e.g., distances from the first end 123M5), lengths along the longitudinal direction L and widths of the recesses 161aM5, 161bM5, and 161cM5 are not the same. However, at least two of a plurality of projections or recesses may be provided at the same position from the first end 123M5 and/or may have the same length and/or width.

Preferably, at least one of the plurality of projections 160M5 or the plurality of recesses 161M5 may extend along the longitudinal direction L to the first end 123M5 or the second end 124M5 of the main body 121M5. For example, in FIG. 27, at least one of the projection 160bM5 and the recess 161aM5 provided near the first end 123M5 may extend up to the first end 123M5. Alternatively, at least one projection 160M5 and/or at least one recess 161M5 may extend from the first end 123M5 to the second end 124M5 of the main body 121M5 along the longitudinal direction L.

Although not shown in the drawings, the projections 160M5 and the recesses 161M5 provided on the curved surface 145M5 of the inner surface 144M5 of the first flow path 143M5 and the projections 160M5 and the recesses 161M5 provided on the inner surface 154M5 of the second flow path 153M5 may have the same structures as the projections 160M5 and the recesses 161M5 shown in FIG. 27.

According to the fifth embodiment, when injecting ink through the ink injection cylinder, the recesses and/or the projections on at least one of the inner surfaces of the first flow path and the second flow path of the ink injection cylinder can prevent ink from forming meniscus in the first flow path and/or the second flow path. Accordingly, the ink surely flows continuously in the first flow path and/or the second flow path, and thus the ink injection operation can be smoothly performed.

According to the fifth embodiment, there is provided an ink injection cylinder used for injecting ink into an ink tank having an ink injection port. The ink injection cylinder extends in a longitudinal direction and includes a main body having a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. At least one of inner surfaces of the first flow path tube and the second flow path tube is provided with a projection projecting with respect to the inner surface and/or a recess recessed with respect to the inner surface.

The inner surface may have at least one curved surface and at least one flat surface, and corners may be formed at positions where the at least one curved surface and the at least one planar surface intersect.

At least one recess and/or at least one projection may be provided on the at least one curved surface, and/or at least one recess and/or at least one projection may be provided on the at least one flat surface.

The at least one curved surface may be a portion of a side surface of a truncated cone and/or a portion of a side surface of a cylinder, and/or the at least one flat surface may be one flat surface.

The ink injection cylinder may include a plurality of the recess and/or the projection. Each of the recesses and/or the projections may extend in the longitudinal direction. A size of at least one of the plurality of recess in the longitudinal direction may be different from sizes of other recesses or projections, and a size of at least one of the projections in the longitudinal direction may be different from sizes of other recesses or projections.

A cross-section perpendicular to the longitudinal direction of the recess and/or the projection may be at least one of a rectangle, an arch, and a trapezoid.

At least one of the recesses and/or at least one of the projections may extend up to the first end and/or the second end along the longitudinal direction.

The ink injection cylinder may include a plurality of the recess and/or the projection. A size of a recess of at least one of the plurality of recess may be different from the other recesses, and/or a size of at least one of the plurality of projections is different from the other projections.

According to the fifth embodiment, there is further provided an ink tank for use in an inkjet printer having a recording engine. The ink tank includes an ink tank main body and a film adhered thereto. The ink tank main body includes an ink storage chamber configured to store ink to be supplied to the recording engine, an ink injection port in communication with the ink storage chamber, and any of the ink injection cylinders described above. The ink injection cylinder extends through the ink injection port to the ink storage chamber, and the first opening and the third opening are disposed outside the ink tank main body. The first flow path communicates with the ink storage chamber through the second opening, and the second flow path communicates with the ink storage chamber through the fourth opening.

The first opening and the third opening are used to communicate with a container containing ink to be injected into the ink storage chamber.

According to the fifth embodiment, there is further provided an inkjet printer including a recording engine and any of the above-described ink tanks.

### Sixth Embodiment

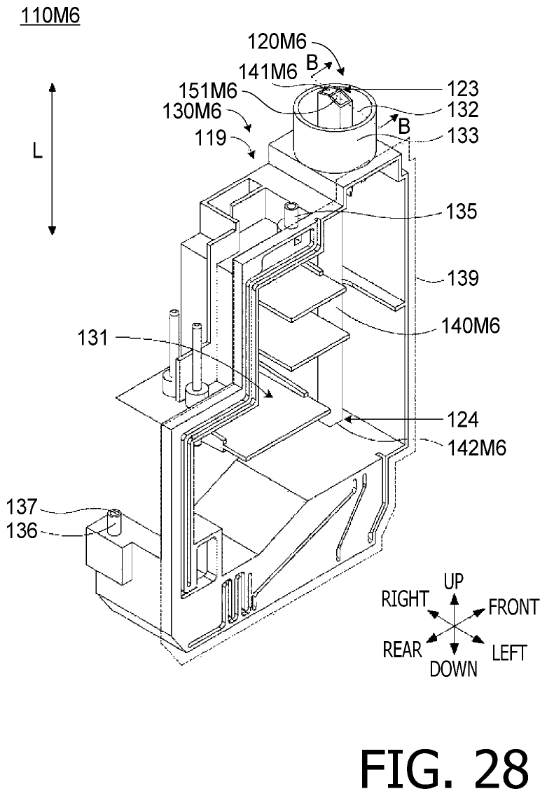

FIGS. 1 and 28 to 30 show an ink injection cylinder 120M6 according to a sixth embodiment of the present disclosure, an ink tank 110M6 having the ink injection cylinder 120M6, and an inkjet printer 100 having the ink tank 110M6. An ink tank main body 130M6 of the sixth embodiment has substantially the same structure as the ink tank main bodies 30 and 130 of the background art and the first embodiment. Therefore, in order to simplify the description, structures having the same functions as those of the background art and the first embodiment will not be described in detail again, and only different technical features will be described. Structures having the same functions as those of the background art and the first embodiment and not appearing in the description of the present embodiment are denoted by the same reference numerals as those of the first embodiment.

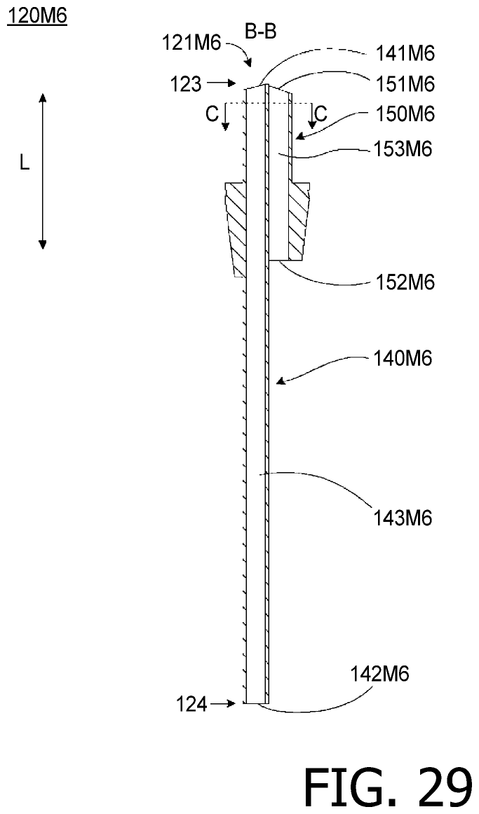

As shown in FIG. 29, the ink injection cylinder 120M6 has a main body 121M6 extending along the longitudinal direction L. The main body 121M6 mainly includes a first flow path tube 140M6 and a second flow path tube 150M6.

The first flow path tube 140M6 extends along the longitudinal direction L and has a first opening 141M6, a second opening 142M6, and a first flow path 143M6 formed between the first opening 141M6 and the second opening 142M6. The second flow path tube 150M6 extends along the longitudinal direction L and has a third opening 151M6, a fourth opening 152M6, and a second flow path 153M6 formed between the third opening 151M6 and the fourth opening 152M6. In order to reduce the possibility of the formation of meniscus in the first flow path and the second flow path during the ink injection process, a cross-sectional shape of at least a portion along the longitudinal direction L of one of the first flow path 143M6 and the second flow path 153M6 cut along a plane perpendicular to the longitudinal direction L is closed, and includes at least three end points.

Preferably, the cross-sectional shapes of the first flow path 143M6 and the second flow path 153M6 cut along a plane perpendicular to the longitudinal direction L are both closed and include at least three end points. Preferably, the cross-sectional shape of the first flow path 143M6 cut along a plane perpendicular to the longitudinal direction L is polygonal, and the cross-sectional shape of the second flow path 153M6 cut along a plane perpendicular to the longitudinal direction L is also polygonal, such as a square, pentagon, hexagon and the like.

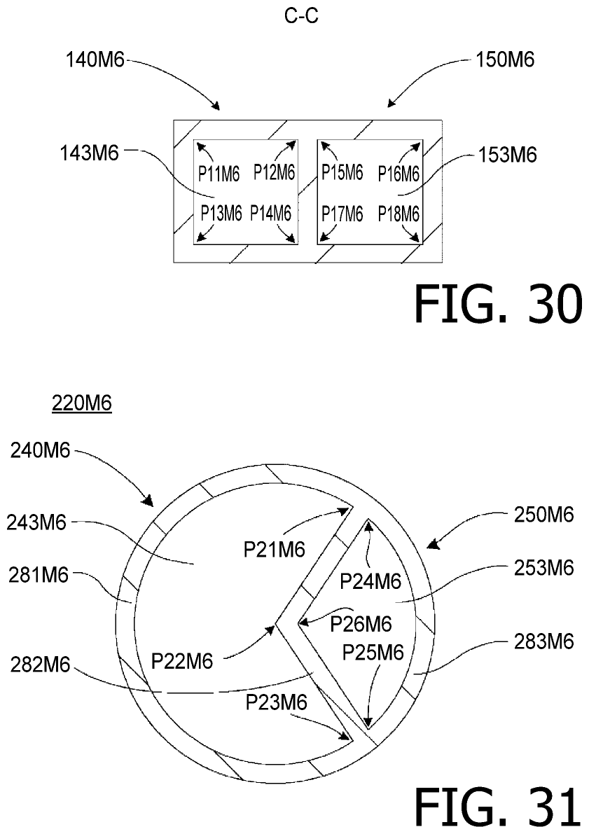

In the sixth embodiment, as shown in FIG. 30, the cross-sectional shapes of the first flow path 143M6 and the second flow path 153M6 cut along a plane perpendicular to the longitudinal direction L are square. More specifically, the cross-sectional shape of the first flow path 143M6 cut along a plane perpendicular to the longitudinal direction L has four end points, namely, an end point P11M6, an end point P12M6, an end point P13M6, and an end point P14M6. The cross-sectional shape of the second flow path 153M6 cut along a plane perpendicular to the longitudinal direction L also has four end points, namely, an end point P15M6, an end point P16M6, an end point P17M6, and an end point P18M6.

Modification 1

FIG. 31 is a cross-sectional view of an ink injection cylinder 220M6 according to Modification 1 of the sixth embodiment of the present disclosure. The ink injection cylinder 220M6 of Modification 1 has substantially the same structure as the ink injection cylinder 120M6 of the sixth embodiment. Therefore, in order to simplify the description, structures having the same functions as those of the sixth embodiment will not be described in detail again, and only different technical features will be described.

Modification 1 differs from the sixth embodiment in that the cross-sectional shape of a second flow path 253M6 cut along a plane perpendicular to the longitudinal direction L has a projected structure, and the cross-sectional shape of a first flow path 243M6 cut along a plane perpendicular to the longitudinal direction L has a recessed structure corresponding to the shape of the projected structure. As shown in FIG. 31, the cross-sectional shapes of the first flow path 243M6 and the second flow path 253M6 cut along the plane perpendicular to the longitudinal direction L are fan shape.

Specifically, the first flow path tube 240M6 includes a first side wall 281M6 extending along the longitudinal direction L and a second side wall 282M6 connected to the first side wall 281M6, and the first side wall 281M6 and the second side wall 282M6 surround the first flow path 243M6. The second flow path tube 250M6 includes a third side wall 283M6 extending along the longitudinal direction L, and the third side wall 283M6 is connected to the second side wall 282M6 and surrounds the second flow path 253M6. The first side wall 281M6 and the third side wall 283M6 are connected to each other, the second side wall 282M6 is provided between the first side wall 281M6 and the third side wall 283M6, and a cross-section of the second side wall 282M6 is V-shaped.

In Modification 1, a cross-sectional shape of the first flow path 243M6 cut along a plane perpendicular to the longitudinal direction L has three end points, namely, an end point P21M6, an end point P22M6, and an end point P23M6. A cross-sectional shape of the second flow path 253M6 cut along a plane perpendicular to the longitudinal direction L has three end points, namely, an end point P24M6, an end point P25M6, and an end point P26M6.

Modification 2

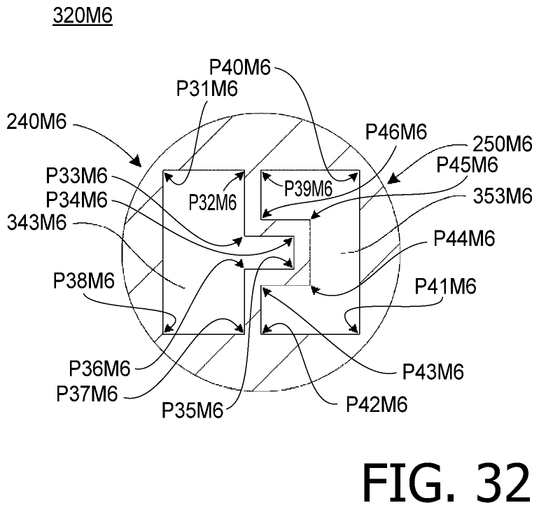

FIG. 32 is a cross-sectional view of an ink injection cylinder 320M6 according to Modification 2 of the sixth embodiment of the present disclosure. The ink injection cylinder 320M6 of Modification 2 has substantially the same structure as the ink injection cylinder 220M6 of Modification 1, and similar numbers are assigned to structures having similar functions. Therefore, in order to simplify the description, structures having the same functions as those of Modification 1 will not be described in detail again, and only different technical features will be described. Structures having the same functions as those of Modification 1 and not appearing in the description of Modification 2 are denoted by the same reference numerals as those of Modification 1.

Modification 2 differs from Modification 1 in that, in Modification 2, a cross-sectional shape of a first flow path 343M6 cut along a plane perpendicular to the longitudinal direction L has a projected structure, and a cross-sectional shape of a second flow path 353M6 cut along a plane perpendicular to the longitudinal direction L has a recessed structure corresponding to the shape of the projected structure.

As shown in FIG. 32, the cross-sectional shape of the first flow path 343M6 cut along a plane orthogonal to the longitudinal direction L is a rectangle with a squarely protruded portion at a central part of one side (i.e., a convexed shape), and the cross-sectional shape of the second flow path 353M6 cut along a plane orthogonal to the longitudinal direction L is a rectangle with a squarely recessed portion at a central part of one side (i.e., a concaved shape).

In Modification 2, the cross-sectional shape of the first flow path 343M6 cut along a plane orthogonal to the longitudinal direction L has eight end points, namely, an end point P31M6, an end point P32 M6, an end point P33 M6, an end point P34 M6, an end point P35 M6, an end point P36 M6, an end point P37 M6, and an end point P38 M6. the cross-sectional shape of the second flow path 353M6 cut along a plane orthogonal to the longitudinal direction L has eight end points, namely, an end point P39 M6, an end point P40 M6, an end point P41 M6, an end point P42 M6, an end point P43 M6, an end point P44 M6, an end point P45 M6, and an end point P46 M6.

According to the inkjet printer of the sixth embodiment, at least a portion of at least one of the first flow path and the second flow path of the ink injection cylinder of the ink tank along the longitudinal direction has a closed cross-sectional shape cut along a plane perpendicular to the longitudinal direction and has at least three end points. Accordingly, the possibility that the meniscus is formed in the first flow path and/or the second flow path during the ink injection process can be reduced, and the temporary stop of the ink injection process can be prevented.

According to the sixth embodiment, there is provided an ink injection cylinder used for injecting ink into an ink tank main body of an ink tank having an ink injection port. The ink injection cylinder is detachably mounted to the ink tank main body by inserting through the ink injection port. The ink injection cylinder has a main body that extends in a longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. A cross section cut along a plane perpendicular to the longitudinal direction of at least a portion of at least one of the first flow path and the second flow path along the longitudinal direction has a closed cross-sectional shape and includes at least three end points.

The cross-sectional shape of the first flow path cut along a plane perpendicular to the longitudinal direction may be closed and may include at least three end points, and/or the cross-sectional shape of the second flow path cut along a plane perpendicular to the longitudinal direction may be closed and may include at least three end points.

The cross-sectional shape of the first flow path cut along a plane perpendicular to the longitudinal direction may be polygonal, and/or the cross-sectional shape of the second flow path cut along a plane perpendicular to the longitudinal direction may also be polygonal.

The cross-sectional shape of the first flow path cut along a plane perpendicular to the longitudinal direction may be a square, and/or the cross-sectional shape of the second flow path cut along a plane perpendicular to the longitudinal direction may also be a square.

The first flow path tube and the second flow path tube may be provided side by side, and the cross-sectional shape of one of the first flow path and the second flow path cut along a plane perpendicular to the longitudinal direction may have a projected structure, and the cross-sectional shape of the other of the first flow path and the second flow path cut along a plane perpendicular to the longitudinal direction may have a recessed structure corresponding to the projected structure.

The cross-sectional shape of the first flow path cut along a plane perpendicular to the longitudinal direction is fan-shaped, and/or the cross-sectional shape of the second flow path cut along a plane perpendicular to the longitudinal direction is fan-shaped.

The first flow path tube may include a first side wall extending along the longitudinal direction and a second side wall connected to the first side wall, and the first flow path may be surrounded by the first side wall and the second side wall. The second flow path tube may include a third side wall extending along the longitudinal direction, and the third side wall may be connected to the second side wall to surround the second flow path.

The first side wall and the third side wall may be connected to each other to form a circular structure, and the second side wall may be provided between the first side wall and the third side wall. A cross section of the second side wall may be V-shaped.

According to the sixth embodiment, there is further provided an ink tank for use in an inkjet printer having a recording engine. The ink tank includes an ink tank main body and a film adhered thereto. The ink tank main body includes an ink storage chamber configured to store ink to be supplied to the recording engine, an ink injection port in communication with the ink storage chamber, and any of the ink injection cylinders described above. The ink injection cylinder is detachably mounted to the ink tank main body by inserting through the ink injection port, and the first opening and the third opening are disposed outside the ink tank main body. The first flow path communicates with the ink storage chamber through the second opening, and the second flow path communicates with the ink storage chamber through the fourth opening.

According to the sixth embodiment, there is further provided an inkjet printer including a recording engine and any of the above-described ink tanks.

### Seventh Embodiment

FIGS. 1 and 33 to 35 show an ink tank 110M7 according to a seventh embodiment of the present disclosure, and an inkjet printer 100 having the ink tank 110M7.

The ink tank 110M7 of the seventh embodiment has substantially the same structure as the ink tanks 10 and 110 of the background art and the first embodiment. Therefore, in order to simplify the description, structures having the same functions as those of the background art and the first embodiment will not be described in detail again, and only different technical features will be described. Structures having the same functions as those of the background art and the first embodiment and not appearing in the description of the present embodiment are denoted by the same reference numerals as those of the first embodiment.

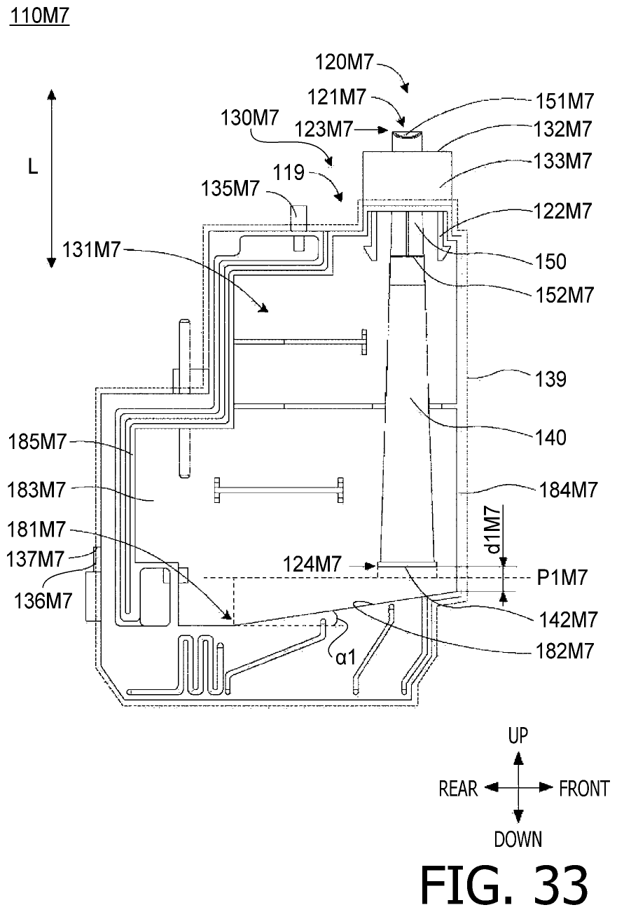

As shown in FIG. 33, the ink tank 110M7 includes an ink tank main body 130M7 and an ink injection cylinder 120M7. The ink injection cylinder 120M7 is detachably attached to the ink tank main body 130M7. The ink tank main body 130M7 mainly includes an ink storage chamber 131M7, an ink injection port 132M7, an ink injecting part 133M7, an ink supplying part 135M7, an air communicating part 136M7, and an air communication port 137M7.

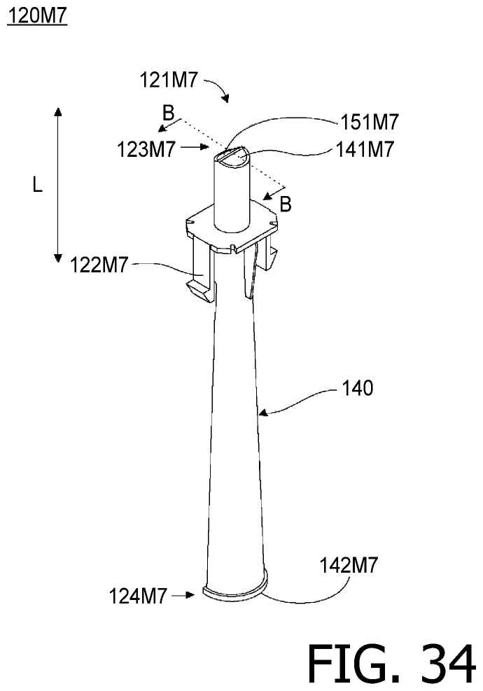

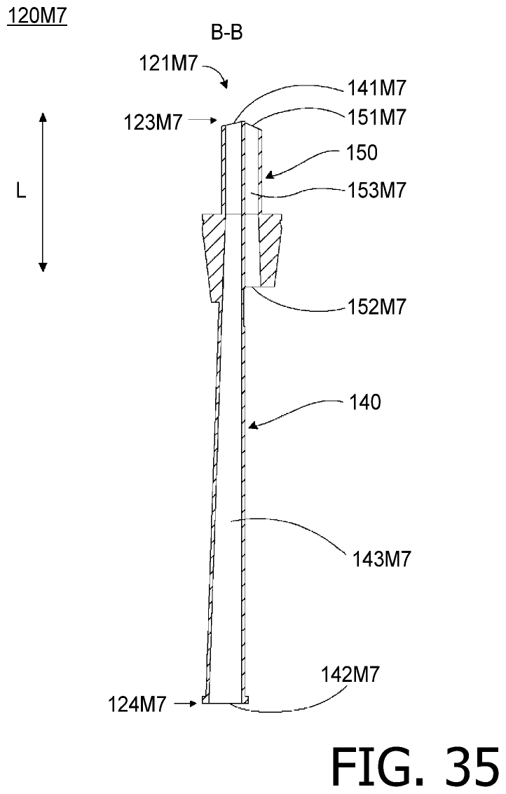

As shown in FIGS. 33 and 34, the ink injection cylinder 120M7 further includes mounts 122M7 integrally molded with the main body 121M7. The ink injection cylinder 120M7 is fixed to the ink tank main body 130M7 via the mounts 122M7. Each mount 122M7 is provided on an outer side the main body 121M7, has an engaging structure, and is engaged with the ink tank main body 130M7. In FIGS. 33 and 34, two mounts 122M7 are shown, and the two mounts 122M7 are provided to the main body 121M7 at the same height with a prescribed distance therebetween. As will be appreciated by those skilled in the art, the number of mounts 122M7 is not limited to two. The number of mounts may be one, or may be more than two, such as three, as needed. As shown in FIGS. 33 and 35, the ink injection cylinder 120M7 extends through the ink injection port 132M7, a first end 123M7 of the main body 121M7 is located above the ink injection port 132M7, a second end 124M7 of the main body 121M7 extends into the ink storage chamber 131M7, and the mounts 122M7 also extends into the ink storage chamber 131M7 to engage with the ink tank main body 130M7. Thus, the first opening 141M7 and the third opening 151M7 are located outside the ink storage chamber 131M7, a first flow path 143M7 communicates with the ink storage chamber 131M7 through a second opening 142M7, a second flow path 153M7 communicates with the ink storage chamber 131M7 through a fourth opening 152M7, the second opening 142M7 is facing and spaced from a later-described bottom wall 181M7, and a shortest distance d1M7 between the second opening 142M7 and the bottom wall 181M7 is 2.5 mm or less.

The ink storage chamber 131M7 has the bottom wall 181M7. An upper surface of the bottom wall 181M7 includes a flow section 182M7 inclined with respect to the horizontal direction. At least a portion of a projection of the second opening 142M7 projected on a horizontal plane P1M7 is located inside a projection of the flow section 182M7 projected on the horizontal plane P1M7, and an angle α1 between the flow section 182M7 and the horizontal plane P1M7 is 2.4 degrees or more. Preferably, the angle α1 between the flow section 182M7 and the horizontal plane P1M7 is 3 degrees or more.

In the present embodiment, the entire projection of the second opening 142M7 projected on the horizontal plane P1M7 is located inside projection of the flow section 182M7 projected on the horizontal plane P1M7. Thus, the flow section 182M7 has the function of guiding flow of ink and makes it possible to prevent the ink from staying between the second opening 142M7 and the flow section 182M7 during the ink injection.

The ink storage chamber 131M7 has a side wall 183M7, a first end wall 184M7 and a second end wall 185M7, each connected to the bottom wall 181M7. The first end wall 184M7 and the second end wall 185M7 are connected to the side wall 183M7 and are located on both sides of the side wall 183M7. The ink injection cylinder 120M7 is provided between the first end wall 184M7 and the second end wall 185M7 with intervals. A distance between the ink injection cylinder 120M7 and the first end wall 184M7 is shorter than a distance between the ink injection cylinder 120M7 and the second end wall 185M7. Preferably, the flow section 182M7 extends obliquely downward from the first end wall 184M7 toward the second end wall 185M7. In other words, the ink injection cylinder 120M7 is provided to a front portion of the ink tank main body 130M7, and the flow section 182M7 extends obliquely downward in a direction toward the rear. As a result, ink injected through the ink injection cylinder 120M7 flows downward from a relatively high position to a relatively low position of the flow section 182M7, and thus the ink do not stay between the second opening 142M7 and the flow section 182M7. In the present embodiment, the flow section 182M7 is continuous with the first end wall 184M7 and is spaced from the second end wall 185M7. It should be noted that the flow section 182M7 may be continuous with the second end wall 185M7 as necessary.

Modification 1

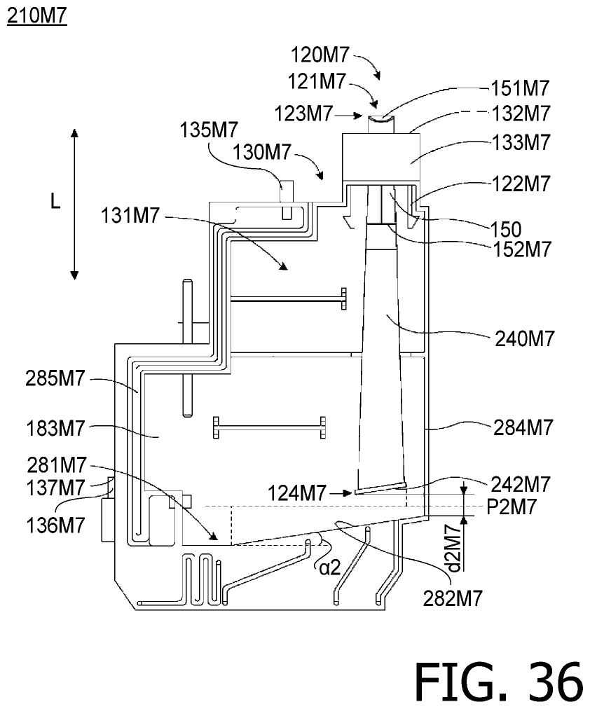

FIG. 36 shows an ink tank 210M7 according to Modification 1 of the seventh embodiment of the present disclosure. The ink tank 210M7 of Modification 1 has substantially the same structure as the ink tank 110 of the seventh embodiment. Therefore, in order to simplify the description, structures having the same functions as those of the seventh embodiment will not be described in detail again, and only different technical features will be described. Structures having the same functions as those of the seventh embodiment and not appearing in the description of the present modification are denoted by the same reference numerals as those of the seventh embodiment or the first embodiment.

In Modification 1, a shortest distance d2M7 between a second opening 242M7 of a first flow path tube 240M7 and a bottom wall 281M7 is 2.5 mm or less, and an entire projection of the second opening 242M7 projected on a horizontal plane P2M7 are located inside a projection of a flow section 282M7 projected on the horizontal plane P2M7. An angle α2 between the flow section 282M7 and the horizontal plane P2M7 is 2.4 degrees or more.

Modification 1 differs from the seventh embodiment in that a plane on which the second opening 242M7 lies is inclined with respect to the horizontal plane P2M7 and extends while obliquely downward from a first end wall 284M7 toward a second end wall 285M7. Preferably, the plane on which the second opening 242M7 lies is parallel to the flow section 282M7.

Modification 2

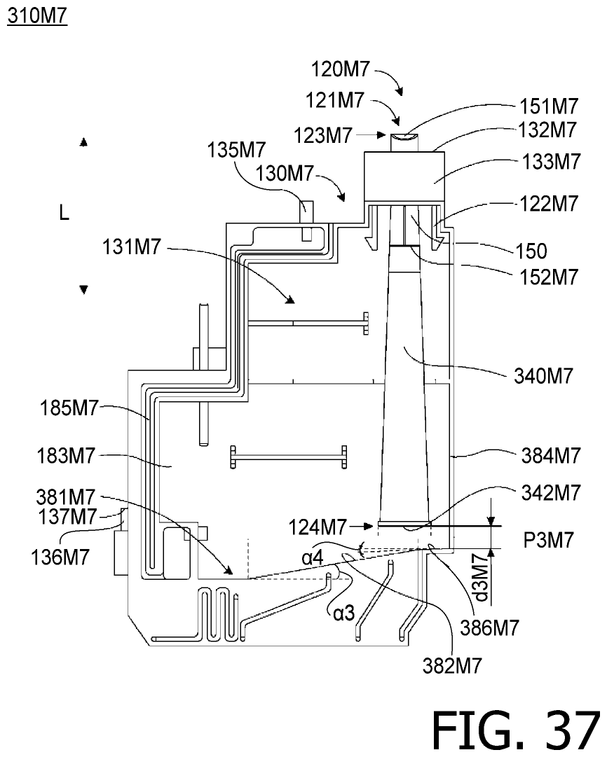

FIG. 37 shows an ink tank 310M7 according to Modification 2 of the seventh embodiment of the present disclosure. The ink tank 310M7 of Modification 2 has substantially the same structure as the ink tank 110M7 of the seventh embodiment. Therefore, in order to simplify the description, structures having the same functions as those of the seventh embodiment will not be described in detail again, and only different technical features will be described. Structures having the same functions as those of the seventh embodiment and not appearing in the description of the present modification are denoted by the same reference numerals as those of the seventh embodiment or the first embodiment.

In Modification 2, a shortest distance d3M7 between a second opening 342M7 of a first flow passage tube 340M7 and a bottom wall 381M7 is 2.5 mm or less, and a portion of a projection of the second opening 342M7 projected on a horizontal plane P3M7 is located inside a projection of a flow section 382M7 projected on the horizontal plane P3M7. An angle α3 between the flow section 382M7 and the horizontal plane P3M7 is 2.4 degrees or more.

Modification 2 differs from the seventh embodiment in that an upper surface of the bottom wall 381M7 includes an inclined surface 386M7. The inclined surface 386M7 is located between an inner surface of a first end wall 384M7 and the flow section 382M7, and the angle α3 between the flow section 382M7 and the horizontal plane P3M7 is larger than an angle α4 between the inclined surface 386 and the horizontal plane P3M7.

According to the inkjet printer of the seventh embodiment, since the flow section inclined with respect to the horizontal direction is provided on the upper surface of the bottom wall of the ink storage chamber of the ink tank, and at least a portion of the projection of the second opening projected on the horizontal plane is located inside the projection of the flow section projected on the horizontal plane, the flow section has the function of guiding the flow of ink and makes it possible to prevent the ink from staying between the second opening and the flow section during the ink injection. Therefore, the possibility that the meniscus is formed at the second opening during the ink injection process can be reduced, and the temporary stop of the ink injection process can be prevented.

According to the seventh embodiment, there is provided an ink tank for use in an inkjet printer having a recording engine. The ink tank includes an ink storage chamber configured to store ink to be supplied to the recording engine and having a bottom wall, an ink injection port in communication with the ink storage chamber, and an ink injection cylinder having a main body that extends in a longitudinal direction and has a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. A distance from the first opening to the first end is shorter than a distance from the second opening to the first end. The second flow path tube extends in the longitudinal direction and has a third opening, a fourth opening, and a second flow path formed between the third opening and the fourth opening. A distance from the third opening to the first end is shorter than a distance from the fourth opening to the first end, and a distance from the fourth opening to the first end is shorter than a distance from the second opening to the first end. The ink injection cylinder extends through the ink injection port, and the first opening and the third opening are disposed outside the ink storage chamber. The first flow path communicates with the ink storage chamber through the second opening, and the second flow path communicates with the ink storage chamber through the fourth opening. The second opening is facing and spaced from the bottom wall. A shortest distance between the second opening and the bottom wall is 2.5 mm or less. An upper surface of the bottom wall includes a flow section inclined with respect to a horizontal direction. At least a portion of a projection of the second opening projected on a horizontal plane is located inside a projection of the flow section projected on the horizontal plane. An angle between the flow section and the horizontal plane is 2.4 degrees or more.

The angle between the flow section and the horizontal plane may be three degrees or more.

The ink storage chamber has a side wall, a first end wall and a second end wall each connected to the bottom wall. The first end wall and the second end wall are connected to the side wall and are provided on both sides of the side wall, the ink injection cylinder is provided between the first end wall and the second end wall with intervals. A distance between the ink injection cylinder and the first end wall may be shorter than a distance between the ink injection cylinder and the second end wall.

The flow section may extend obliquely downward along a direction from the first end wall toward the second end wall.

The flow section may be connected to the first end wall.

A plane on which the second opening lies may be parallel to the horizontal plane.

The plane on which the second opening lies may be inclined with respect to the horizontal plane and extend obliquely downward along a direction from the first end wall toward the second end wall.

The plane on which the second opening lies may be parallel to the flow section.

An upper surface of the bottom wall may include an inclined surface. The inclined surface may be located between an inner surface of the first end wall and the flow section. An angle between the flow section and the horizontal plane may be larger than the angle between the inclined surface and the horizontal plane.

According to the seventh embodiment, there is further provided an inkjet printer including a recording engine and any of the above-described ink tanks.

### Eighth Embodiment

Hereinafter, an ink tank 110M8 according to an eighth embodiment of the present disclosure will be described. The ink tank 110M8 has substantially the same structure as the ink tanks 10 and 110 of the background art and the first embodiment. Therefore, in order to simplify the description, structures having the same functions as those of the background art and the first embodiment will not be described in detail again, and only different technical features will be described. Structures having the same functions as those of the background art and the first embodiment and not appearing in the description of the present embodiment are denoted by the same reference numerals as those of the first embodiment.

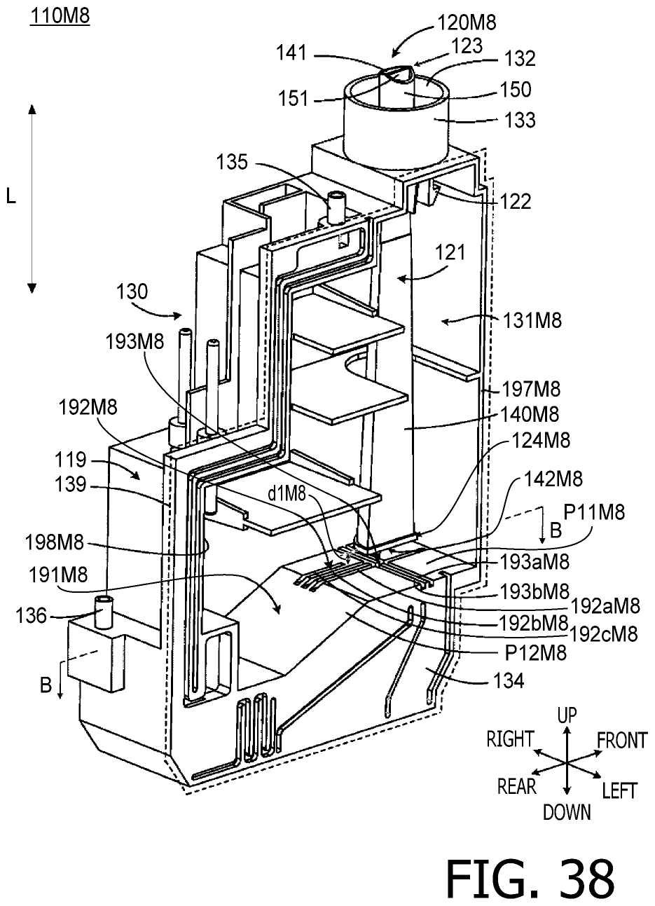

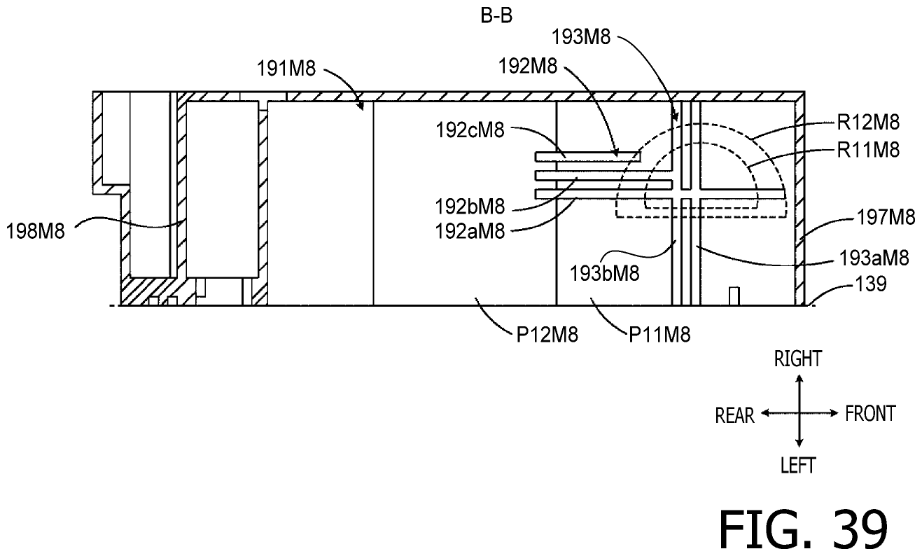

As shown in FIG. 38, grooves are provided on the upper surface of a bottom wall 191M8. The grooves are formed between projections projecting from the upper surface or is recessed downward from the upper surface. In the illustrated embodiment, the groove is recessed downward from the upper surface. All the grooves are provided in the ink storage chamber 131M8. As shown in FIG. 39, at least a portion of the grooves is located outside a projection area R11M8, and at least a portion of the grooves is located inside a prescribed area R12M8. The projection area R11M8 is an area formed at a portion where an outer contour of an end portion of a first flow path tube 140M8 where a second opening 142M8 is formed is projected on the upper surface. The “end portion” refers to a second end 124M8. The prescribed area R12M8 has a shape similar to a shape of the projection area R11M8 and has an area N times larger than that of the projection area R11M8, where 1<N≤2.25. For example, the first flow path tube 140M8 may be a semi-cylindrical body, whereby the projection area R11M8 has a semi-circular shape. Similarly, the prescribed area R1M82 also has a semi-circular shape.

The projection area R11M8 is entirely located within the prescribed area R12M8. Preferably, sides of the prescribed area R12M8 correspond to sides of the projection area R11M8 on a one to-one basis. The corresponding sides are adjacent to each other. For example, an arc-shaped side of the prescribed area R12M8 corresponds to and is adjacent to an arc-shaped side of the projection area R11M8.

According to the eighth embodiment, in the ink injection process, ink flows downward from the first flow path tube 140M8 of the ink injection cylinder 120M8, flows out from the second opening 142M8, and then diffuses at high speed on the upper surface of the bottom wall 191M8.

Extending directions of the grooves are parallel to the upper surface of the bottom wall 191M8. At least a portion of the grooves extends along a direction from a first end wall 197M8 toward a second end wall 198M8. The grooves may include first grooves 192M8 and second grooves 193M8. An extending direction of the first grooves 192M8 is not the same as an extending direction of the second grooves 193M8.

For example, in the eighth embodiment illustrated in the drawings, the first groove 192M8 extends in the front-rear direction, that is, the first grooves 192M8 extend in a direction from the first end wall 197M8 toward the second end wall 198M8. The second grooves 193M8 extend in the left-right direction. It should be noted that the arrangement of the first grooves 192M8 and the second grooves 193M8 is not limited to that of the illustrated embodiment shown in the drawings.

The first grooves 192M8 and the second groove 193M8 intersect with each other and communicate with each other at the intersection. According to the present embodiment, ink flowing out of the second opening 142M8 diffuses at high speed inside the first groove 192M8 and the second groove 193M8. At least two first grooves 192 and at least two second grooves 193 may be provided on the upper surface of the bottom wall 191M8. The adjacent first grooves are spaced apart, and the adjacent second grooves are also spaced apart.

A portion of a first groove 192aM8 on the left is located outside the prescribed area R12M8, and the other portion extends through the projection area R11M8 via the prescribed area R12M8. A portion of a middle, first groove 192bM8 is located outside the prescribed area R12M8, and the other portion extends to the inside of the projection area R11M8 via the prescribed area R12M8. A portion of a first groove 192cM8 on the right is located outside the prescribed area R12M8, and the other portion extends into the prescribed area R12M8 but does not extend into the projection area R11M8. A front, second groove 193aM8 and a rear, second groove 193bM8 extend through the prescribed area R12M8 and the projection area R11M8. The first groove 192aM8 on the left intersects and is in communication with the second groove 193aM8 on the front and the second groove 193bM8 on the back. The first groove 192bM8 in the middle intersects and is in communication with the second groove 193bM8 on the back.

The upper surface of the bottom wall 191M8 includes a first surface P11M8 facing the second opening 142M8 and a second surface P12M8 connected to the first surface P11M8 and extending obliquely downward from the first surface P11M8 toward the second end wall 198M8. The second surface P12M8 is an inclined surface that is angled with respect to the first surface P11M8. The first surface P11M8 is extending substantially horizontally, and may be a horizontal surface. The first surface P11M8 may be an inclined surface that is angled with respect to the horizontal direction. In the present embodiment, inclining directions of the first surface P11M8 and the second surface P12M8 are the same, and the inclination angles may or may not be the same. In the present embodiment, ink flowing out of the second opening 142M8 firstly flows on the bottom wall 191M8 in a direction from the first surface P11M8 toward the second surface P12M8. The extending direction of the first grooves 192M8 may be the direction from the first surface P11M8 to the second surface P12M8 which is the same as the direction in which ink firstly flows on the bottom wall 191M8.

At least a portion of the grooves may extend to where the second surface P12M8 intersects with the first surface P11M8. Such embodiment promotes high-speed flow of ink from the first surface P11M8 to the second surface P12M8.

Alternatively, at least a portion of the grooves may extend from the first surface P11M8 to the top, middle, or lower portion of the second surface P12M8. Such embodiment promotes high-speed flow of ink from the first surface P11M8 to the second surface P12M8 and diffusion of ink over the second surface P12M8. In the illustrated embodiment, all three first grooves 192M8 extend up where the second surface P12M8 and the first surface P11M8 intersects with each other. It should be noted that positions of end portions of the three first grooves 192M8 extending toward the second surface P12M8 may not be the same.

Modification 1

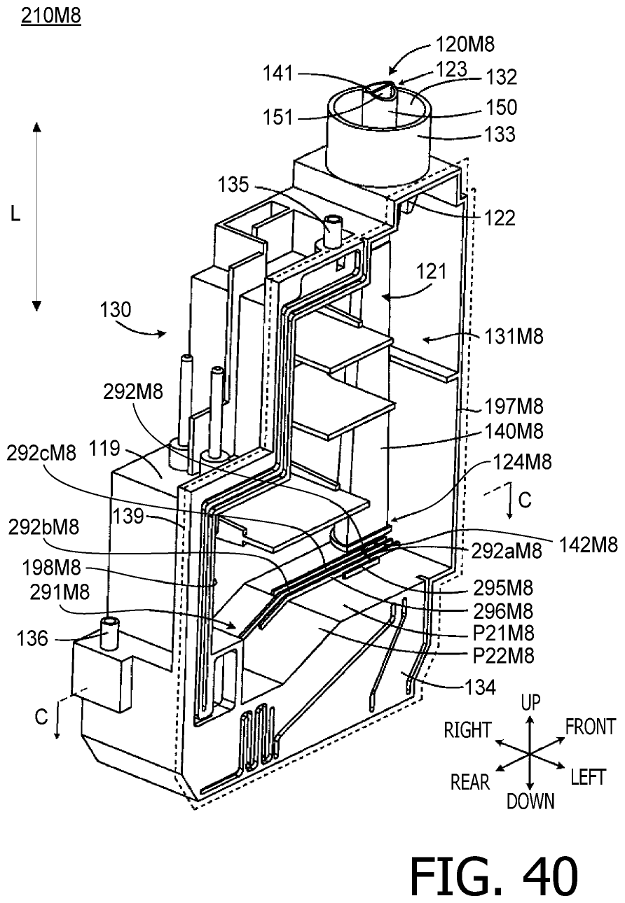

FIG. 40 shows an ink tank 210M8 according to Modification 1 of the eighth embodiment of the present disclosure. The ink tank 210M8 of Modification 1 has substantially the same structure as the ink tank 110M8 of the eighth embodiment except for the grooves. Therefore, in order to simplify the description, structures having the same functions as those of the eighth embodiment will not be described in detail again, and only different technical features will be described. Structures having the same functions as those of the eighth embodiment and not appearing in the description of the present modification are denoted by the same reference numerals as those of the eighth embodiment or the first embodiment.

As shown in FIG. 40, a plurality of walls are provided on an upper surface of a bottom wall 291M8. The walls are projecting from the upper surface of the bottom wall 291M8, thereby forming grooves between the walls. Specifically, the bottom wall 291M8 is provided with first walls 295M8 and second walls 296M8 each extending upward from the upper surface. The first walls 295M8 and the second walls 296 are arranged parallel to each other and spaced apart from each other to form a groove therebetween. It can be said that the first wall 295M8 and the second wall 296M8 form side walls of the groove, and the upper surface of the bottom wall 291M8 forms a bottom wall of the groove.

In Modification 1 shown in the drawings, first grooves 292M8 are illustrated. Since the first walls 295M8 and the second walls 296M8 all extend in the front-rear direction, first grooves 292M8 extending in the front-rear direction are formed. Furthermore, the first walls 295M8 and the second walls 296M8 all extend in a direction from a first surface P21M8 toward a second surface P22M8. Therefore, in this Modification 1, the first grooves 292M8 extend in the direction from the first surface P21M8 toward the second surface P22M8. In the illustrated embodiment, three first grooves 292M8 are shown.

The first walls 295M8 and the second walls 296M8 all extending in the front-rear direction are formed so as to correspond to the first grooves 292M8. It should be noted that, although not illustrated in the embodiment, at least one second groove may be provided.

The second groove may extend in the left-right direction, and corresponding first wall and second wall may be formed.

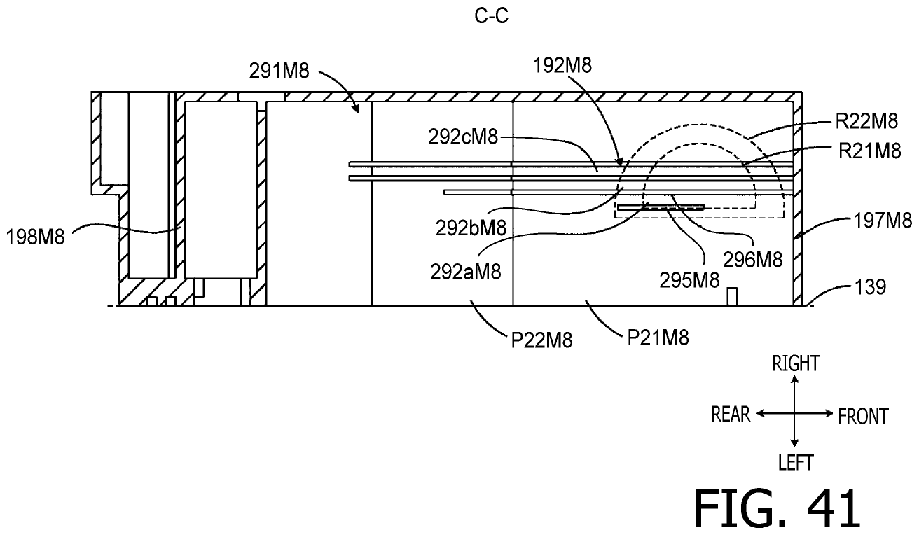

As shown in FIG. 41, a length of a first groove 292aM8 on the left, a length of a first groove 292bM8 at the center, and a length of a first groove 292cM8 on the right are not the same. The first groove 292aM8 on the left extends up to a prescribed area R22M8, and a portion of the first groove 292aM8 is located inside a projection area R21M8. The first groove 292bM8 at the center extends through the prescribed area R22M8 and the projection area R21M8, thereby extending from the first surface P21M8 to the middle of the second surface P22M8. The first groove 292cM8 on the right extends through the prescribed area R22M8 and the projection area R21M8, thereby extending from the first surface P21M8 to the lowermost portion of the second surface P22M8.

Modification 2

In Modification 2, an inkjet printer includes a first ink tank and a second ink tank 310M8. The first ink tank has substantially the same structure as the ink tank 110M8 of the eighth embodiment or the ink tank 210M8 of Modification 1 of the eighth embodiment.

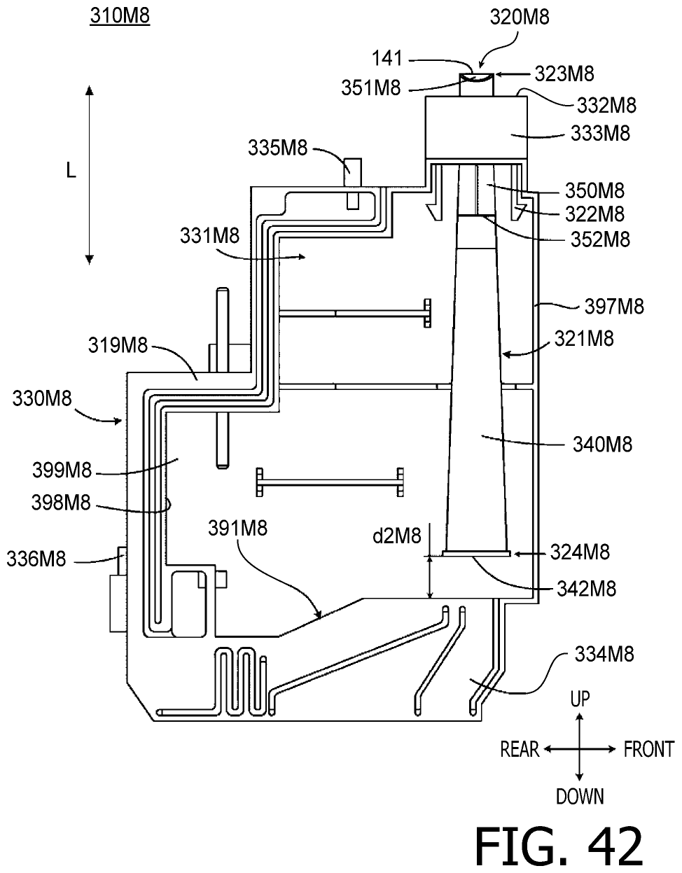

Furthermore, the second ink tank 310M8 has substantially the same structure as the ink tank 110M8 of the eighth embodiment except for the grooves. Therefore, in order to simplify the description, structures having the same functions as those of the eighth embodiment or Modification 1 will not be described in detail again, and only different technical features will be described. Structures having the same functions as those of the eighth embodiment t or Modification 1 and not appearing in the description of the present modification are denoted by the same reference numerals as those of the eighth embodiment, Modification 1, or the first embodiment. it should also be noted that, in FIG. 42, a film is omitted.

As shown in FIG. 42, the second ink tank 310M8 includes an ink tank main body 330M8 and an ink injection cylinder 320M8. The ink tank main body 330M8 includes an ink storage chamber 331M8, an ink injection port 332M8, an ink injecting part 333M8, a buffer chamber 334M8, an ink supplying part 335M8, and an air communicating part 336M8. The ink storage chamber 331M8 has a bottom wall 391M8, a first end wall 397M8, a second end wall 398M8, and a side wall 399M8. The ink tank main body 330M8 includes a resin housing 319M8 and a film. Similar to the viewing surface 37 of the background art, the first end wall 397M8 has a function of a viewing window.

The ink injection cylinder 320M8 has a main body 321M8 and mounts 322M8. The ink injection cylinder 320M8 is fixed to the ink tank main body 330M8 by the mounts 322M8. The main body 321M8 includes a first end 323M8 and a second end 324M8. The main body 321M8 also includes a first flow path tube 340M8 and a second flow path tube 350M8. The first flow path tube 340M8 extends along the longitudinal direction L and has a first opening, a second opening 342M8, and a first flow path. The second flow path tube 350M8 extends along the longitudinal direction L and has a third opening 351M8, a fourth opening 352M8, and a second flow path.

A first distance d1M8 (FIG. 38) from the second opening to the bottom wall of the first ink tank is shorter than a second distance d2M8 (FIG. 42) from the second opening 342M8 to the bottom wall 391M8 of the second ink tank 310M8. The grooves are provided on the upper surface of the bottom wall of the first ink tank. The bottom wall 391M8 of the second ink tank 310M8 is not provided with the groove for promoting the flow of ink. For example, the first distance d1M8 is 2.5 mm or less and the second distance d2M8 is greater than 2.5 mm.

In the first ink tank of the present embodiment, the number of grooves may be increased as the distance from the second opening to the bottom wall gets shorter.

According to the eighth embodiment, there is provided an ink tank for use in an inkjet printer having a recording engine. The ink tank includes an ink storage chamber configured to store ink to be supplied to the recording engine and having a bottom wall, an ink injection port in communication with the ink storage chamber, and an ink injection cylinder having a main body that extends in a longitudinal direction and has a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. The ink injection cylinder extends through the ink injection port, and the first opening and the third opening are disposed outside the ink storage chamber. The first flow path communicates with the ink storage chamber through the second opening, and the second flow path communicates with the ink storage chamber through the fourth opening. The second opening is facing and spaced from the bottom wall. A distance between the second opening and the bottom wall is shorter than a distance between the fourth opening and the bottom wall. Grooves are provided on an upper surface of the bottom wall. The grooves are formed between projections projecting from the upper surface or is recessed downward from the upper surface. All the grooves are provided in the ink storage chamber. At least a portion of the grooves is located outside a projection area being a projection, on the upper surface, of an outer contour of an end portion of a first flow path tube to which the second opening is formed, and at least a portion of the grooves is located within a prescribed area. The prescribed area has a shape similar to the shape of the projection area and has an area N times as large as the projection area, where 1<N≤2.25, and the projection area is entirely located within the prescribed area.

An extending direction of the grooves may be parallel to the upper surface.

The grooves may include a first groove and a second groove, and an extending direction of the first groove may be different from an extending direction of the second groove.

The first groove and the second groove may intersect with each other and communicate with each other.

The ink storage chamber may include a first end wall and a second end wall each connected to the bottom wall and opposed to each other, and the ink injection cylinder may be located between the first end wall and the second end wall. A distance between the ink injection cylinder and the first end wall may be shorter than a distance between the ink injection cylinder and the second end wall.

At least a portion of the grooves may extend in a direction from the first end wall to the second end wall.

The upper surface may include a first surface facing the second opening and a second surface connected to the first surface and extending obliquely downward from the first surface toward the second end wall, and at least a portion of the grooves may extend to where the second surface intersects with the first surface or may extend from the first surface to the second surface.

The bottom wall may be provided with a first wall and a second wall each extending upward from the upper surface, and the groove may be formed by the first wall being parallel to and spaced from the second wall.

According to the eighth embodiment, there is further provided an inkjet printer including a recording engine and any of the above-described ink tanks.

The inkjet printer includes a first ink tank and a second ink tank. A distance from the second opening of the first ink tank to a bottom wall of the first ink tank is shorter than a distance from a second opening of the second ink tank to a bottom wall of the second ink tank, and grooves are provided on an upper surface of the bottom wall of the first ink tank.

### Ninth Embodiment

Hereinafter, an ink tank 110M9 according to a ninth embodiment of the present disclosure will be described. The ink tank 110M9 has substantially the same structure as the ink tanks 10 and 110 of the background art and the first embodiment. Therefore, in order to simplify the description, structures having the same functions as those of the background art and the first embodiment will not be described in detail again, and only different technical features will be described. Structures having the same functions as those of the background art and the first embodiment and not appearing in the description of the present embodiment are denoted by the same reference numerals as those of the first embodiment.

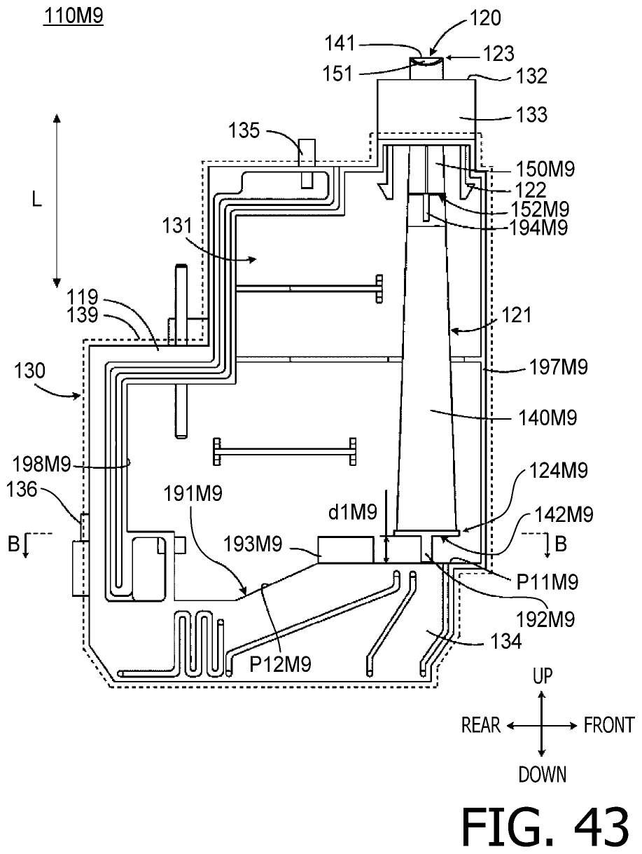

As shown in FIG. 43, the ink tank 110M9 includes at least one of a first flow member 192M9, a second flow member 193M9 and a third flow member 194M9. The first flow member 192M9 may be provided in a first flow path tube 140M9 and extend longitudinally beyond a second opening 142M9. The second flow member 193M9 may be provided on a bottom wall 191M9 and may project from an upper surface of the bottom wall 191M9.

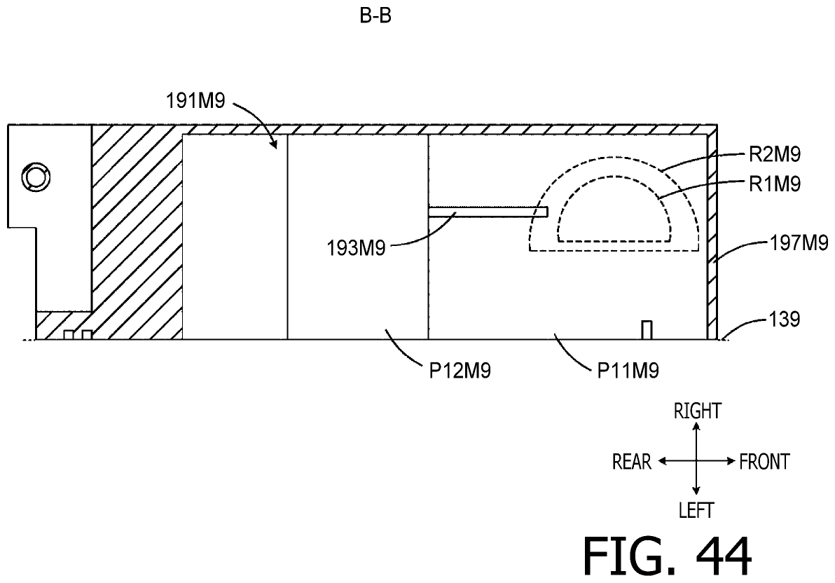

As shown in FIG. 44, at least a portion of the second flow member 193M9 is located within a prescribed area R2M9. The prescribed area R2M9 is an area that has a shape similar to the shape of a projection area R1M9 formed by a projection, on the upper surface, of an outer contour of an end portion of the first flow path tube 140M9 where the second opening 142M9 is formed, and has an area N times as large as the projection area R1M9, where 1<N≤2.25. The “end portion” refers to a second end 124M9. For example, the first flow path tube 140M9 may be a semi-cylindrical body, whereby the projection area R1M9 has a semi-circular shape. In this case, the prescribed area R2M9 also has a semi-circular shape.

The projection area R1M9 is entirely located within the prescribed area R2M9. Preferably, sides of the prescribed area R2M9 correspond to sides of the projection area R1M9 on a one to-one basis. The corresponding sides are adjacent to each other. For example, an arc-shaped side of the prescribed area R2M9 corresponds to and is adjacent to an arc-shaped side of the projection area R1M9.

The third flow member 194M9 may be provided in a second flow path tube 150M9 and extend longitudinally beyond a fourth opening 152M9.

According to this embodiment, ink can flow at high speed and will not stay in the second opening 142M9 of the first flow path tube 140M9 and/or the fourth opening 152M9 of the second flow path tube 150M9. Gas-liquid interface formed by the flow of ink becomes unstable due to the high-speed outflow of ink, and is easily destroyed. Therefore, it is possible to suppress the formation of the meniscus shaped gas-liquid interface, and thus the ink continuously flows in the ink injection process and the temporary stop of the ink injection process, that is, repetition of start and stop of the ink injection during the ink injection process can be avoided. Therefore, ink injection efficiency can be improved and thus can improve usability by the user.

The first flow member 192M9 is located within the projection area R1M9. It should be noted that at least a portion of the first flow member 192M9 may be located outside the projection area R1M9, and the first flow member 192M9 may be protruding from an outer contour the second end 124M9. Preferably, the first flow member 192M9 may extend downwardly from the second end 124M9 and contacts the bottom wall 191M9. According to the ninth embodiment, ink contacts the bottom wall 191M9 at high speed and diffuses over the bottom wall 191M9. The first flow member 192M9 may be a member integrated with the first flow path tube 140M9, and may have any shape such as a long block shape.

A portion of the second flow member 193M9 is located outside the prescribed area R2M9 and the remaining portion extends into the prescribed area R2M9. It should be noted that, if demanded and/or desired, the second flow member 193M9 may extend straight into the projection area R1M9. The second flow member 193M9 may be spaced apart from the first flow member 192M9.

Preferably, the second flow member 193M9 may be in contact with the first flow path tube 140M9 and, in particular, may be in contact with the outer contour or a lower surface of the second end 124M9 of the ink injection cylinder. In such embodiment, ink can contact the second flow member 193M9 at high speed, thereby flowing to the bottom wall 191M9 and diffusing over the bottom wall 191M9.

The third flow member 194M9 extends downward from an end portion of the second flow path tube 150M9 where the fourth opening 152M9 is formed. The third flow member 194M9 may be a member integrated with the second flow path tube 150M9, and may have any shape such as a long block shape.

The ninth embodiment shown in the drawings includes one first flow member 192M9, one second flow member 193M9 and one third flow member 194M9. However, the number of the first flow member 192M9, the second flow member 193M9 and the third flow member 194M9 is not limited to one and thus two or more may be provided as necessary.

An extending direction of the second flow member 193M9 is parallel to the upper surface of the bottom wall 191M9.

In the ninth embodiment shown in the drawings, the second flow member 193M9 extends in a direction from a first end wall 197M9 toward a second end wall 198M9, that is, in the front-rear direction. It should be noted that the direction in which the second flow member 193M9 extends is not limited to the direction in the embodiment shown in the drawings.

The upper surface of the bottom wall 191M9 includes a first surface P11M9 facing the second opening 142M9 and a second surface P12M9 connected to the first surface P11M9 and extending obliquely downward from the first surface P11M9 toward the second end wall 198M9. The second surface P12M9 is an inclined surface that is angled with respect to the first surface P11M9. The first surface P11M9 is extending substantially horizontally, and may be a horizontal surface. The first surface P11M9 may be an inclined surface that is angled with respect to the horizontal direction. In the present embodiment, inclining directions of the first surface P11M9 and the second surface P12M9 are the same, and the inclination angles may or may not be the same. In the present embodiment, ink flowing out of the second opening 142M9 firstly flows on the bottom wall 191M9 in a direction from the first surface P11M9 toward the second surface P12M9. An extending direction of the second flow member 193M9 may be the direction from the first surface P11M9 toward the second surface P12M9 which is the same as a direction in which ink firstly flows on the bottom wall 191M9.

Second flow member 193M9 may extend up to the second surface P12M9 where it intersects with the first surface P11M9.

In such embodiment, high-speed flow of ink from the first surface P11M9 to the second surface P12M9 can be promoted.

The second flow member 193M9 may extend from the first surface P11M9 to the top, middle, or lower portion of the second surface P12M9. Such embodiment promotes high-speed flow of ink from the first surface P11M9 to the second surface P12M9 and diffusion of ink over the second surface P12M9.

Modification 1

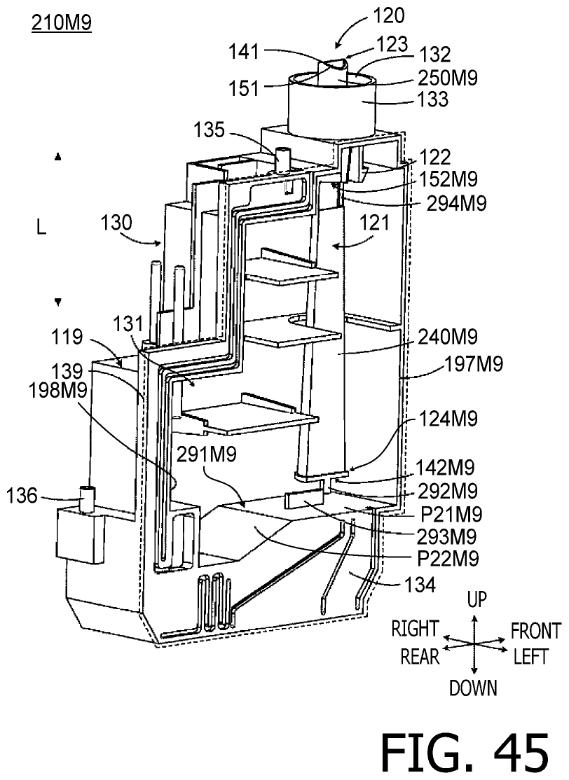

FIG. 45 shows an ink tank 210M9 of an inkjet printer according to Modification 1 of the ninth embodiment of the present disclosure. The ink tank 210M9 of Modification 1 has substantially the same structure as the ink tank 110M9 of the ninth embodiment except for the positional relationship between the first flow member and the second flow member. Therefore, in order to simplify the description, structures having the same functions as those of the ninth embodiment will not be described in detail again, and only different technical features will be described. Structures having the same functions as those of the ninth embodiment and not appearing in the description of the present modification are denoted by the same reference numerals as those of the ninth embodiment or the first embodiment.

In Modification 1, a first flow path tube 240M9 is provided with a first flow member 292M9. The first flow member 292M9 has substantially the same structure as the first flow member 192M9 of the ninth embodiment.

A bottom wall 291M9 is provided with a second flow member 293M9. The second flow member 293M9 has substantially the same structure as the second flow member 193M9 of the ninth embodiment. A difference is that the second flow member 293M9 extends up to the first flow member 292M9 and is in contact with the first flow member 292M9. According to Modification 1, ink flows at high speed through the first flow member 292M9 and the second flow member 293M9 to the bottom wall 291M9, and diffuses on the bottom wall 291M9. A second flow path tube 250M9 is provided with a third flow member 294M9. The third flow member 294 has substantially the same structure as the third flow member 194M9 of the ninth embodiment.

An upper surface of the bottom wall 291M9 includes a first surface P21M9 and a second surface P22M9. The second flow member 293M9 is provided on the first surface P21M9. The second flow member 293M9 may be in contact with a lower surface of the first flow member 292M9. In the present embodiment, at least a portion of the second flow member 293M9 is located below the first flow member 292M9. Alternatively, the second flow member 293M9 may be in contact with a side surface of the first flow member 292M9. In such embodiment, the second flow member 293M9 is located on one side of the first flow member 292M9.

Modification 2

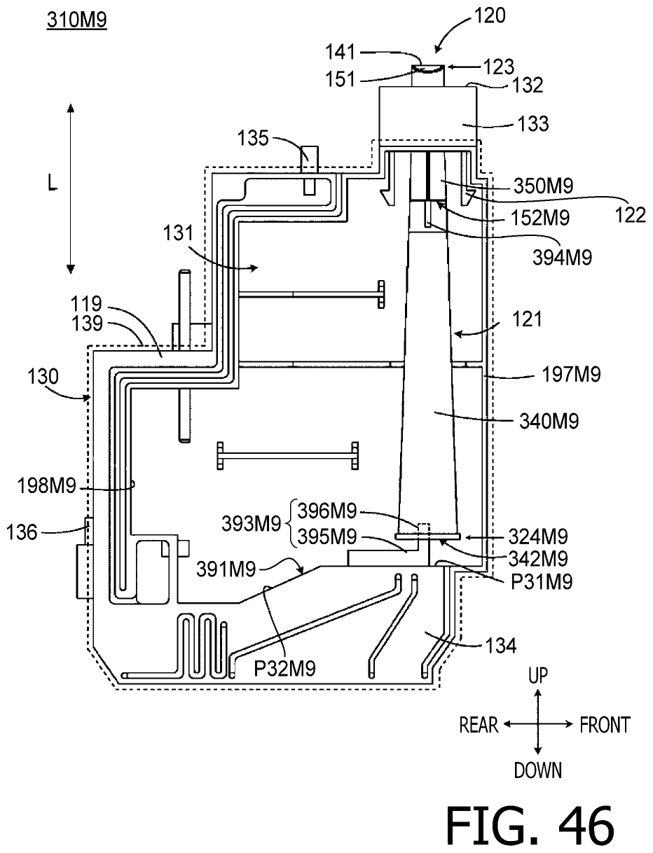

FIG. 46 shows an ink tank 310M9 according to Modification 2 of the ninth embodiment of the present disclosure. The ink tank 310M9 of Modification 2 has substantially the same structure as the ink tank 110M9 of the ninth embodiment except for the first flow member and the second flow member. Therefore, in order to simplify the description, structures having the same functions as those of the ninth embodiment will not be described in detail again, and only different technical features will be described. Structures having the same functions as those of the ninth embodiment and not appearing in the description of the present modification are denoted by the same reference numerals as those of the ninth embodiment or the first embodiment.

As shown in FIG. 46, in Modification 2, the ink tank 310M9 does not have the first flow member. A bottom wall 391M9 is provided with a second flow member 393M9. The second flow member 393M9 has substantially the same structure as the second flow member 193M9 of the ninth embodiment, but differs from the second flow member 193M9 in that a portion of the second flow member 393M9 extends and enters a first flow path tube 340M9. A second flow path tube 350M9 is provided with a third flow member 394M9. The third flow member 394M9 has substantially the same structure as the third flow member 194M9 of the ninth embodiment.

An upper surface of the bottom wall 391M9 includes a first surface P31M9 and a second surface P32M9. The second flow member 393M9 is provided on the first surface P31M9. The second flow member 393M9 includes a flow member main body 395M9 connected to the bottom wall 391M9 and a projection 396M9 connected to the flow member main body 395M9. The flow member main body 395M9 is located below a second end 324M9. The projection 396M9 projects from the flow member main body 395M9, and at least a portion thereof extends into the first flow path tube 340M9 through a second opening 342M9. In the present embodiment, the projection 396M9 can directly break gas-liquid interface formed at the second opening 342M9. Therefore, ink surely smoothly flows out and will not stay at the second opening 342M9. The flow member main body and the projection may be an integral member.

Modification 3

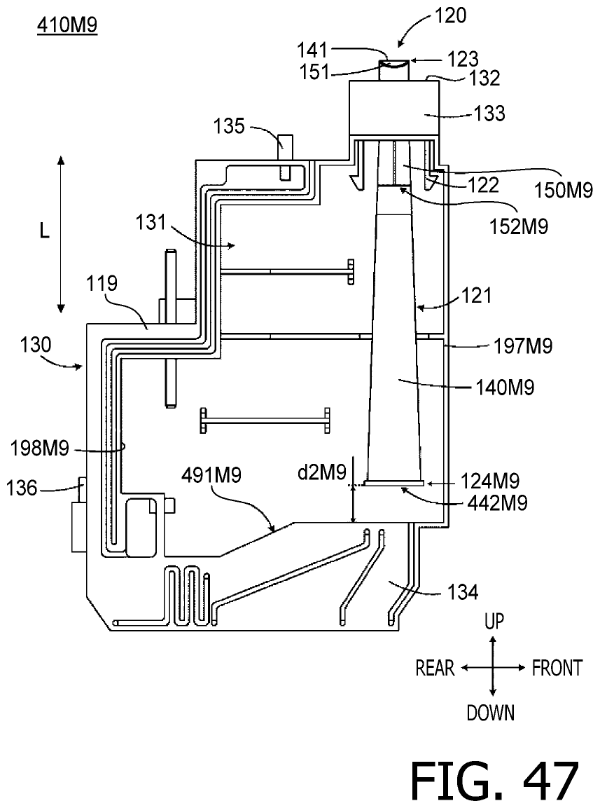

FIG. 47 shows an ink tank 410M9 of an inkjet printer according to Modification 3 of the ninth embodiment of the present disclosure. In Modification 3, the inkjet printer includes a first ink tank and a second ink tank 410M9. The first ink tank has substantially the same structure as the ink tank 110M9 according to the ninth embodiment, the ink tank 210M9 according to Modification 1 of the ninth embodiment, or the ink tank 310M9 according to Modification 2 of the ninth embodiment.

Furthermore, the second ink tank 410M9 has substantially the same structure as the ink tank 110M9 of the ninth embodiment except for the flow member. Therefore, in order to simplify the description, structures having the same functions as those of the ninth embodiment, Modification 1 or Modification 2 will not be described in detail again, and only different technical features will be described. Structures having the same functions as those of the ninth embodiment, Modification 1 or Modification 2 and not appearing in the description of the present modification are denoted by the same reference numerals as those of the ninth embodiment or the first embodiment. it should also be noted that, in FIG. 47, a film is omitted.

The first distance d1M9 (FIG. 43) from the second opening to the bottom wall of the first ink tank is shorter than the second distance d2M9 (FIG. 47) from a second opening 442M9 to a bottom wall 491M9 of the second ink tank 410M9. The first ink tank is provided with at least one of the first flow member, the second flow member, and the third flow member. The second ink tank 410M9 is not provided with flow members such as the first flow member, the second flow member, and the third flow member. For example, the first distance d1M9 is 2.5 mm or less and the second distance d2M9 is greater than 2.5 mm.

In the first ink tank of the present embodiment, the number of flow members may be increased as the distance from the second opening to the bottom wall gets shorter.

According to the ninth embodiment, there is provided an ink tank for use in an inkjet printer having a recording engine. The ink tank includes an ink storage chamber configured to store ink to be supplied to the recording engine and having a bottom wall, an ink injection port in communication with the ink storage chamber, and an ink injection cylinder having a main body that extends in a longitudinal direction and has a first end and a second end opposite to the first end in the longitudinal direction. The main body includes a firth flow path tube and a second flow path tube. The first flow path tube extends in the longitudinal direction and has a first opening, a second opening, and a first flow path formed between the first opening and the second opening. The second flow path tube extends in the longitudinal direction and has a third opening, a fourth opening, and a second flow path formed between the third opening and the fourth opening. The ink injection cylinder extends through the ink injection port, and the first opening and the third opening are disposed outside the ink storage chamber. The first flow path communicates with the ink storage chamber through the second opening, and the second flow path communicates with the ink storage chamber through the fourth opening. The second opening is facing and spaced from the bottom wall. A distance between the second opening and the bottom wall is shorter than a distance between the fourth opening and the bottom wall. the ink tank includes at least one of a first flow member, a second flow member, and a third flow member. The first flow member is provided to the first flow path tube and extends beyond the second opening in the longitudinal direction. The second flow member is provided on the bottom wall and projects from the upper surface of the bottom wall. At least a portion of the second flow member is located within a prescribed area. The prescribed area is an area that has a shape similar to a shape of a projection area formed by a projection, on the upper surface, of an outer contour of an end portion of the first flow path tube where the second opening is formed, and has an area N times as large as the projection area, where 1<N≤2.25. The projection area is entirely within the prescribed area. The third flow member is provided to the second flow path tube and extends beyond the fourth opening in the longitudinal direction.

The first flow member may be in contact with the bottom wall, and/or the second flow member may be in contact with the first flow passage tube.

The second flow member may include a flow member main body connected to the bottom wall, and a projection projecting from the flow member main body and at least a portion extending into the first flow path tube through the second opening.

The ink tank may include the first flow member and the second flow member, and the second flow member is in contact with a lower surface or a side surface of the first flow member.

An extending direction of the second flow member may be parallel to the upper surface of the bottom wall.

The ink storage chamber may include a first end wall and a second end wall each connected to the bottom wall and opposed to each other, and the ink injection cylinder may be located between the first end wall and the second end wall. A distance between the ink injection cylinder and the first end wall may be shorter than a distance between the ink injection cylinder and the second end wall.

The second flow member may extend along a direction from the first end wall toward the second end wall.

The upper surface may include a first surface facing the second opening and a second surface connected to the first surface and extending obliquely downward from the first surface toward the second end wall, and the second flow member may extend to where the second surface intersects with the first surface or may extend from the first surface to the second surface.

According to the ninth embodiment, there is further provided an inkjet printer including a recording engine and any of the above-described ink tanks.

The inkjet printer includes a first ink tank and a second ink tank. A distance from the second opening of the first ink tank to a bottom wall of the first ink tank is shorter than a distance from a second opening of the second ink tank to a bottom wall of the second ink tank, and the first ink tank includes at least one of the first flow member, the second flow member and the third flow member.

It should be noted that each technical feature of each embodiment can be implemented in any combination. For the sake of brevity, not all possible combinations of the technical features described in the foregoing embodiments have been described. However, there is no inconsistency in the combinations of the technical features, and all the combinations are within the scope of this disclosure.

There is also provided an ink tank including any of the ink injection cylinders described above.

There is further provided an inkjet printer including a recording engine and any of the ink tanks described above.

Except for specific definitions, definitions of technical and scientific terms used herein are the same as those generally understood by those skilled in the art. The terms used in this description are used to describe specific embodiments and are not intended to limit the scope of the disclosure. The term “member” or the like appearing in this description indicates one member, but may indicate a combination of a plurality of members. The terms “mount,” “provide,” and the like appearing in this description indicate that one member is directly connected to another member, but may also indicate that one member is connected to another member via an intermediate member.

While aspects of the present disclosure have already been described through the embodiments described above, it should be understood that the embodiments described above are intended to use to describe by way of example and that the essence of the aspects of the present disclosure are not limited to the scope of the embodiments described above. Those skilled in the art will also appreciate that the aspects of the present disclosure are not limited to the embodiments described above, and that the disclosure may be subject to many further variations and modifications. Accordingly, these variations and modifications are within the scope of the present disclosure.

What is claimed is:

1. An ink injection cylinder used for injecting ink into an ink tank having an ink injection port, the ink injection cylinder comprising:
a first flow path tube extending in a longitudinal direction and having a first opening on one side in the longitudinal direction, a second opening on another side in the longitudinal direction, and a first flow path formed between the first opening and the second opening; and
a second flow path tube extending in the longitudinal direction and having a third opening on the one side in the longitudinal direction, a fourth opening on the other side in the longitudinal direction, and a second flow path formed between the third opening and the fourth opening,
wherein at least one of a first virtual plane including at least a portion of an end surface of the second opening of the first flow path tube and a second virtual plane including at least a portion of an end surface of the fourth opening of the second flow path tube intersects with a plane orthogonal to the longitudinal direction.

2. The ink injection cylinder according to claim 1, wherein at least one of the end surface of the second opening and the end surface of the fourth opening has a recessed shape, a projected shape, a saw-tooth shape, or a curved surface.

3. The ink injection cylinder according to claim 1, wherein the first flow path tube and the second flow path tube are integrally molded.

4. The ink injection cylinder according to claim 1, wherein a cross-sectional area of the first flow path tube along a plane intersecting the longitudinal direction gradually increases from the first opening toward the second opening.

5. The ink injection cylinder according to claim 1, wherein the first opening and the third opening of the ink injection cylinder are used to communicate with a container that stores ink to be supplied to the ink tank.

6. An ink tank for use in an inkjet printer having a recording engine, the ink tank comprising an ink tank main body and a film adhered thereto,
wherein the ink tank main body comprises:
an ink storage chamber configured to store ink to be supplied to the recording engine;
an ink injection port in communication with the ink storage chamber; and
an injection cylinder comprising:
a first flow path tube extending in a longitudinal direction and having a first opening on one side in the longitudinal direction, a second opening on another side in the longitudinal direction, and a first flow path formed between the first opening and the second opening; and
a second flow path tube extending in the longitudinal direction and having a third opening on the one side in the longitudinal direction, a fourth opening on the other side in the longitudinal direction, and a second flow path formed between the third opening and the fourth opening,
at least one of a first virtual plane including at least a portion of an end surface of the second opening of the first flow path tube and a second virtual plane including at least a portion of an end surface of the fourth opening of the second flow path tube intersecting with a plane orthogonal to the longitudinal direction,
wherein the ink injection cylinder extends through the ink injection port to the ink storage chamber, and the first opening and the third opening are disposed outside the ink tank main body,
wherein the first flow path communicates with the ink storage chamber through the second opening, and the second flow path communicates with the ink storage chamber through the fourth opening.

7. The ink tank according to claim 6, wherein a flat surface of a bottom wall of the ink storage chamber below the second opening is parallel to a plane perpendicular to the longitudinal direction.

8. The ink tank according to claim 6, wherein a flat surface of a bottom wall of the ink storage chamber below the second opening intersects with a plane perpendicular to the longitudinal direction.

9. The ink tank according to claim 8, wherein the flat surface of the bottom wall of the ink storage chamber below the second opening is parallel to a plane including at least a portion of the end surface of the second opening of the first flow path tube.

10. An inkjet printer comprising:
a recording engine; and
an ink tank comprising an ink tank main body and a film adhered thereto,
wherein the ink tank main body comprises:
an ink storage chamber configured to store ink to be supplied to the recording engine;
an ink injection port in communication with the ink storage chamber; and
an injection cylinder comprising:
a first flow path tube extending in a longitudinal direction and having a first opening on one side in the longitudinal direction, a second opening on another side in the longitudinal direction, and a first flow path formed between the first opening and the second opening; and
a second flow path tube extending in the longitudinal direction and having a third opening on the one side in the longitudinal direction, a fourth opening on the other side in the longitudinal direction, and a second flow path formed between the third opening and the fourth opening,
at least one of a first virtual plane including at least a portion of an end surface of the second opening of the first flow path tube and a second virtual plane including at least a portion of an end surface of the fourth opening of the second flow path tube intersecting with a plane orthogonal to the longitudinal direction,
wherein the ink injection cylinder extends through the ink injection port to the ink storage chamber, and the first opening and the third opening are disposed outside the ink tank main body,
wherein the first flow path communicates with the ink storage chamber through the second opening, and the second flow path communicates with the ink storage chamber through the fourth opening.
